(19) United States
(12) Patent Application Publication
(10) Pub. No.: US 2025/0193909 A1
(43) Pub. Date: Jun. 12, 2025

(54) USER EQUIPMENT CAPABILITY FOR SWITCHING BETWEEN FULL DUPLEX MODE AND HALF DUPLEX MODE

(71) Applicant: QUALCOMM Incorporated, San Diego, CA (US)

(72) Inventors: Qian ZHANG, Basking Ridge, NJ (US); Yan ZHOU, San Diego, CA (US)

(21) Appl. No.: 18/533,078

(22) Filed: Dec. 7, 2023

(51) Int. Cl. H04W 72/51; H04B 7/06; H04L 5/14; H04W 72/12

(52) U.S. Cl. CPC H04W 72/51; H04B 7/0626; H04L 5/14; H04W 72/12

(57) ABSTRACT

Various aspects of the present disclosure generally relate to wireless communication. In some aspects, a user equipment (UE) may transmit UE capability information associated with a subband full duplex (SBFD) configuration in which a set of flexible symbols are configured as SBFD symbols with a subband, wherein the UE capability information comprises a UE capability indication associated with switching between a UE full duplex mode and a UE half duplex mode. The UE may communicate in association with the UE capability indication. Numerous other aspects are described.

### FIELD OF THE DISCLOSURE

Aspects of the present disclosure generally relate to wireless communication and specifically relate to techniques, apparatuses, and methods for user equipment capability for switching between full duplex mode and half duplex mode.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIGS. 4A-4C are diagrams illustrating examples of full duplex (FD) communication in accordance with the present disclosure.

FIG. 5 is a diagram illustrating examples of FD communication in a wireless network, in accordance with the present disclosure.

FIGS. 6A and 6B are diagrams illustrating examples associated with subband full duplex (SBFD) configurations, in accordance with the present disclosure.

FIGS. 7A-7D are diagrams illustrating examples of various communication modes in accordance with the present disclosure.

FIG. 8 is a diagram illustrating an example associated with UE capabilities for switching between FD mode and half duplex (HD) mode, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### SUMMARY

In some aspects, a method of wireless communication performed by a user equipment (UE) includes transmitting UE capability information associated with a subband full duplex (SBFD) configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and communicating in association with the UE capability indication.

In some aspects, a method of wireless communication performed by a network node includes receiving, from a UE, UE capability information associated with a subband full duplex (SBFD) configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and communicating in association with the UE capability indication.

In some aspects, a method of wireless communication performed by a UE includes transmitting a CSI report in associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and receiving, in association with the CSI report, configuration information indicating a first set of transmission parameters for a first set of symbols associated with the UE full duplex mode and a second set of transmission parameters for a second set of symbols associated with the UE half duplex mode.

In some aspects, a method of wireless communication performed by a network node includes receiving a CSI report associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and transmitting, in association with the CSI report, configuration information indicating a first set of transmission parameters for a first set of symbols associated with the UE full duplex mode and a second set of transmission parameters for a second set of symbols associated with the UE half duplex mode.

In some aspects, an apparatus for wireless communication at a UE includes one or more memories; and one or more processors, coupled to the one or more memories, configured to cause the UE to: transmit UE capability information associated with a SBFD configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and communicate in association with the UE capability indication.

In some aspects, an apparatus for wireless communication at a network node includes one or more memories; and one or more processors, coupled to the one or more memories, configured to cause the network node to: receive, from a UE, UE capability information associated with a SBFD configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and communicate in association with the UE capability indication.

In some aspects, an apparatus for wireless communication at an UE includes one or more memories; and one or more processors, coupled to the one or more memories, configured to cause the UE to: transmit a CSI report in associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and receive, in association with the CSI report, configuration information indicating a first set of transmission parameters for a first set of symbols associated with the UE full duplex mode and a second set of transmission parameters for a second set of symbols associated with the UE half duplex mode.

In some aspects, an apparatus for wireless communication at a network node includes one or more memories; and one or more processors, coupled to the one or more memories, configured to cause the network node to: receive, from a UE, a CSI report in associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and transmit, in association with the CSI report, configuration information indicating a first set of transmission parameters for a first set of symbols associated with the UE full duplex mode and a second set of transmission parameters for a second set of symbols associated with the UE half duplex mode.

In some aspects, a non-transitory computer-readable medium storing a set of instructions for wireless communication includes one or more instructions that, when executed by one or more processors of a UE, cause the UE to: transmit UE capability information associated with a SBFD configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and communicate in association with the UE capability indication.

In some aspects, a non-transitory computer-readable medium storing a set of instructions for wireless communication includes one or more instructions that, when executed by one or more processors of a network node, cause the network node to: receive, from a UE, UE capability information associated with a SBFD configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and communicate in association with the UE capability indication.

In some aspects, a non-transitory computer-readable medium storing a set of instructions for wireless communication includes one or more instructions that, when executed by one or more processors of an UE, cause the UE to: transmit a CSI report in associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and receive, in association with the CSI report, configuration information indicating a first set of transmission parameters for a first set of symbols associated with the UE full duplex mode and a second set of transmission parameters for a second set of symbols associated with the UE half duplex mode.

In some aspects, a non-transitory computer-readable medium storing a set of instructions for wireless communication includes one or more instructions that, when executed by one or more processors of a network node, cause the network node to: receive a CSI report in associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and transmit, in association with the CSI report, configuration information indicating a first set of transmission parameters for a first set of symbols associated with the UE full duplex mode and a second set of transmission parameters for a second set of symbols associated with the UE half duplex mode.

In some aspects, an apparatus for wireless communication includes means for transmitting capability information associated with a SBFD configuration in which a set of flexible or downlink symbols are configured as SBFD symbols with at least an uplink subband, wherein the UE capability information comprises a capability indication related to at least one of a filter switching capability or a spatial configuration switching capability associated with switching between a UE full duplex mode and a UE half duplex mode; and means for communicating in association with the capability indication.

In some aspects, an apparatus for wireless communication includes means for receiving, from a UE, UE capability information associated with a SBFD configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and means for communicating in association with the UE capability indication.

In some aspects, an apparatus for wireless communication includes means for transmitting a CSI report in associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and means for receiving, in association with the CSI report, configuration information indicating a first set of transmission parameters for a first set of symbols associated with the UE full duplex mode and a second set of transmission parameters for a second set of symbols associated with the UE half duplex mode.

In some aspects, an apparatus for wireless communication includes means for receiving a CSI report in associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and means for transmitting, in association with the CSI report, configuration information indicating a first set of transmission parameters for a first set of symbols associated with the UE full duplex mode and a second set of transmission parameters for a second set of symbols associated with the UE half duplex mode.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate to UE capabilities for switching between a half duplex (HD) communication mode and a full duplex (FD) communication mode. The UE capabilities may include, for example, a UE capability indication related to a filter switching capability and/or a spatial configuration switching capability. In some aspects, a network may configure and/or schedule resources based on the UE capabilities, which may facilitate support for different communication modes at a UE. In some aspects, a UE's capabilities associated with switching between HD and FD communications may be indicated based on classifications. In some aspects, different UE capabilities may be defined for different types of symbols. For example, a UE May have a first set of capabilities associated with flexible symbols and a second set of capabilities associated with semi-static configured SBFD and non-SBFD symbols. In some aspects, based on the spatial configuration switching capability indication, the network node may transmit a spatial configuration switch indication. In some aspects, a spatial configuration switch rule may be indicated by a wireless communication standard and, therefore, maintained in one or more memories of the UE.

Particular aspects of the subject matter described in this disclosure can be implemented to realize one or more of the following potential advantages. In some examples, the described techniques can be used to enable a UE configured for SBFD communications to be able to effectively communicate with a network node. By configuring and/or scheduling resources based on the UE capabilities, which may facilitate support for different communication modes at a UE, some aspects may enable more efficient communications between the network node and the UE. By indicating the UE capabilities to the network node, some aspects may enable a network node to configure and/or schedule resources appropriately. By indicating a spatial configuration switching capability, some aspects may enable a network node to more efficiently configure resources and components of the network node for communicating in accordance with an HD mode of the UE or an FD mode of the UE.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

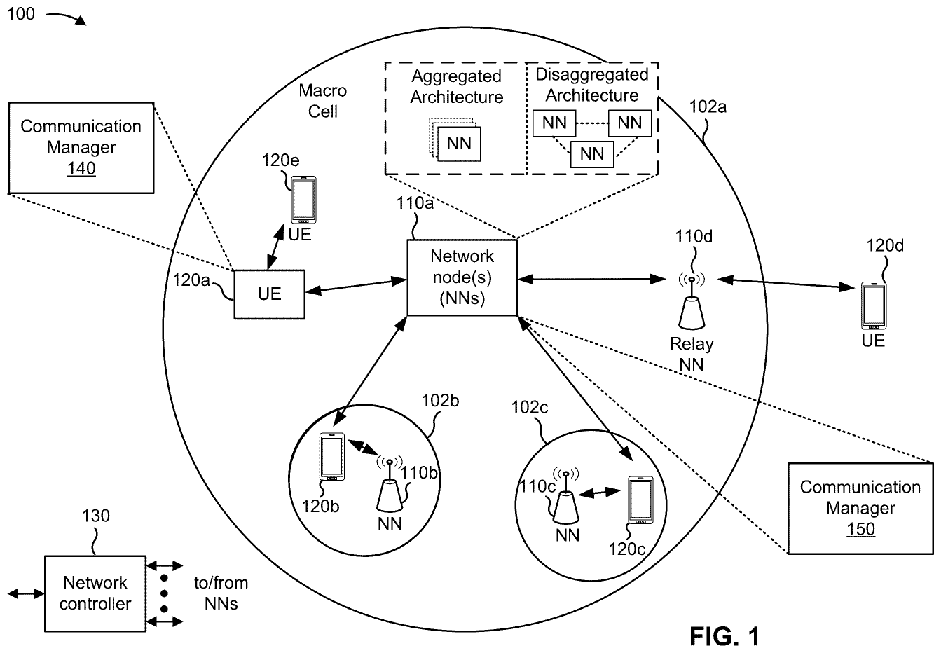

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., the UE 120) may include a communication manager 140. As described in more detail elsewhere herein, the communication manager 140 may transmit UE capability information associated with a subband full duplex (SBFD) configuration in which a set of flexible symbols are configured as SBFD symbols with a subband, wherein the UE capability information comprises a UE capability indication associated with switching between a UE full duplex mode and a UE half duplex mode; and communicate in association with the UE capability indication.

In some aspects, the communication manager 140 may transmit a channel state information (CSI) report associated with an SBFD configuration in which a set of flexible symbols are configured as SBFD symbols with an uplink subband, wherein the CSI report comprises a first CSI feedback hypothesis associated with a UE full duplex mode and a second CSI feedback hypothesis associated with a UE half duplex mode; and receive, in association with the CSI report, configuration information indicating a first set of transmission parameters for a first set of symbols associated with the UE full duplex mode and a second set of transmission parameters for a second set of symbols associated with the UE half duplex mode. Additionally, or alternatively, the communication manager 140 may perform one or more other operations described herein.

In some aspects, a network node (e.g., the network node 110) may include a communication manager 150. As described in more detail elsewhere herein, the communication manager 150 may receive UE capability information associated with an SBFD configuration in which a set of flexible symbols are configured as SBFD symbols with a subband, wherein the UE capability information comprises a UE capability indication associated with switching between a UE full duplex mode and a UE half duplex mode; and communicate in association with the UE capability indication.

In some aspects, the communication manager 150 may receive a CSI report in associated with an SBFD configuration in which a set of flexible symbols are configured as SBFD symbols with an uplink subband, wherein the CSI report comprises a first CSI feedback hypothesis associated with a UE full duplex mode and a second CSI feedback hypothesis associated with a UE half duplex mode; and transmit, in association with the CSI report, configuration information indicating a first set of transmission parameters for a first set of symbols associated with the UE full duplex mode and a second set of transmission parameters for a second set of symbols associated with the UE half duplex mode. Additionally, or alternatively, the communication manager 150 may perform one or more other operations described herein.

As indicated above, FIG. 1 is provided as an example. Other examples may differ from what is described with regard to FIG. 1.

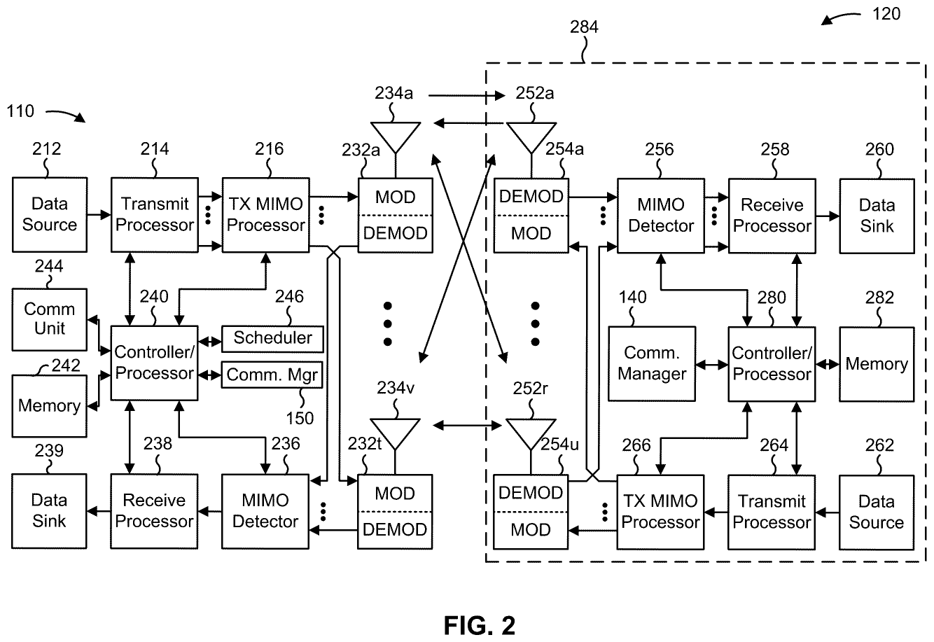

FIG. 2 is a diagram illustrating an example of a network node 110 in communication with a UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

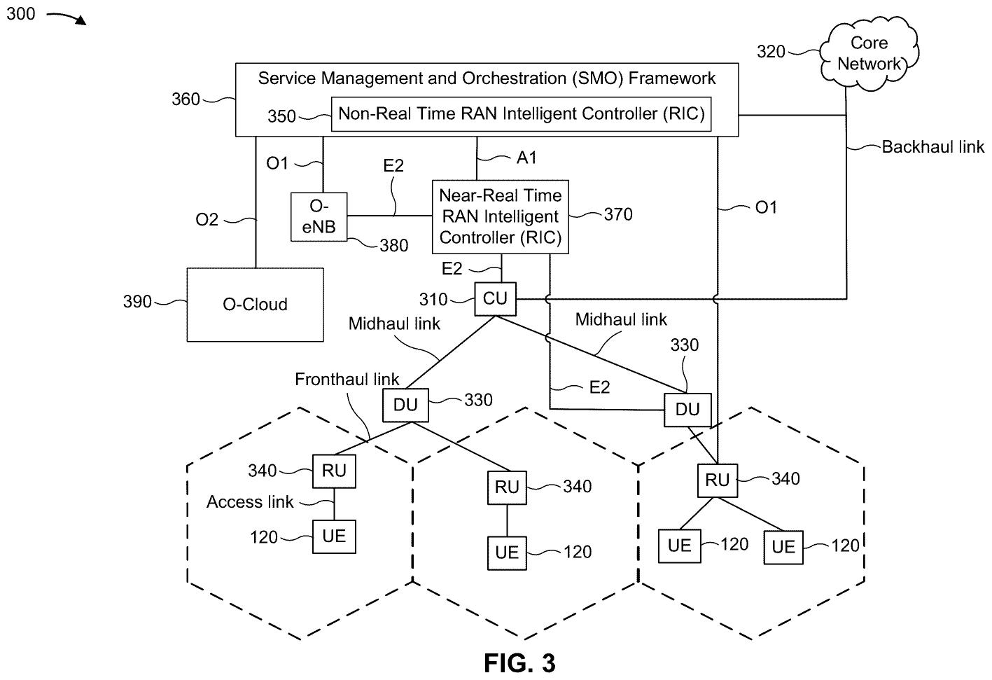

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

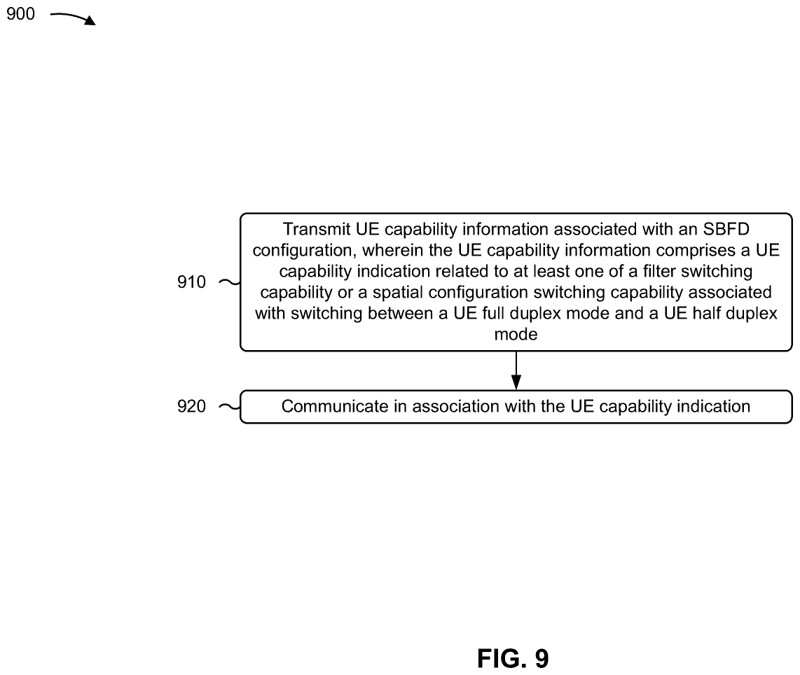

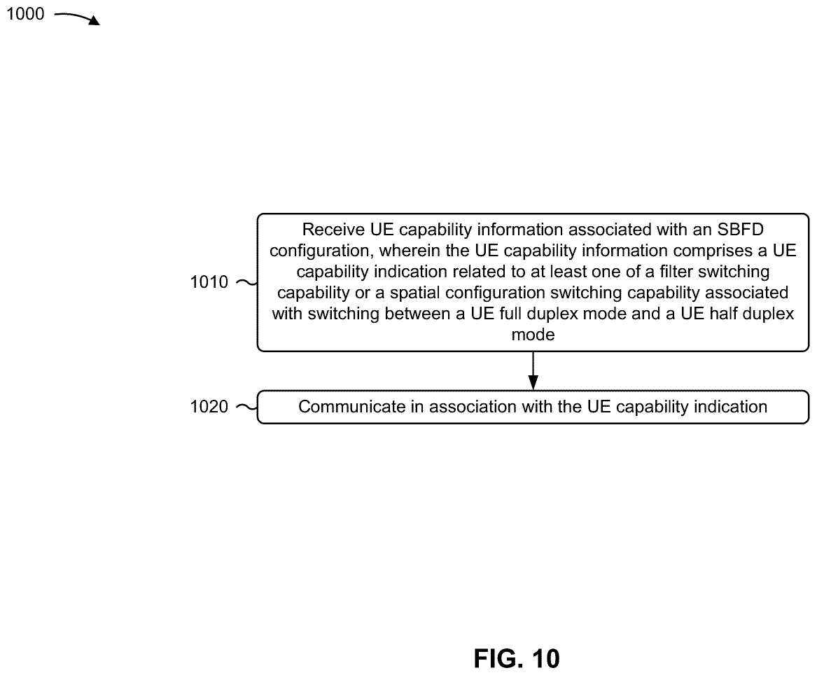

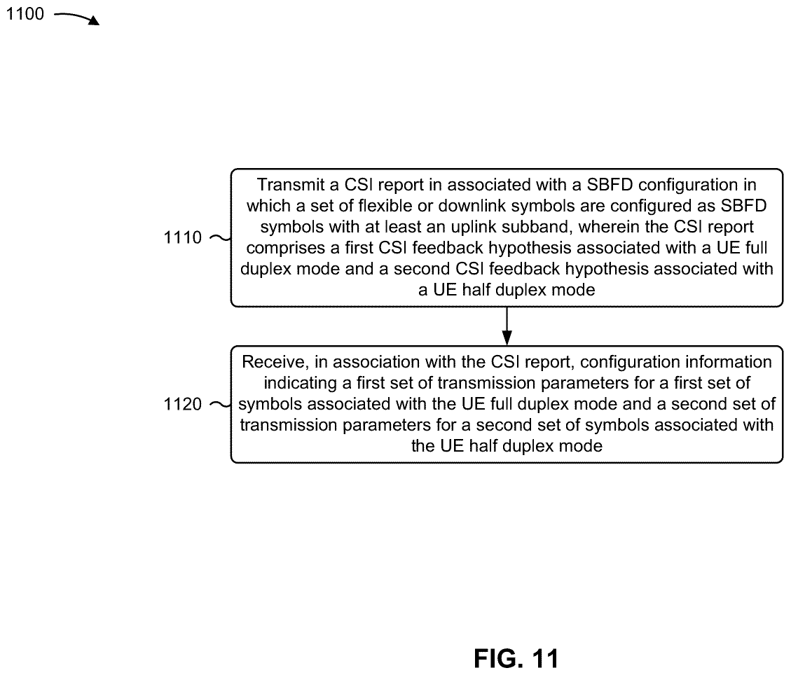

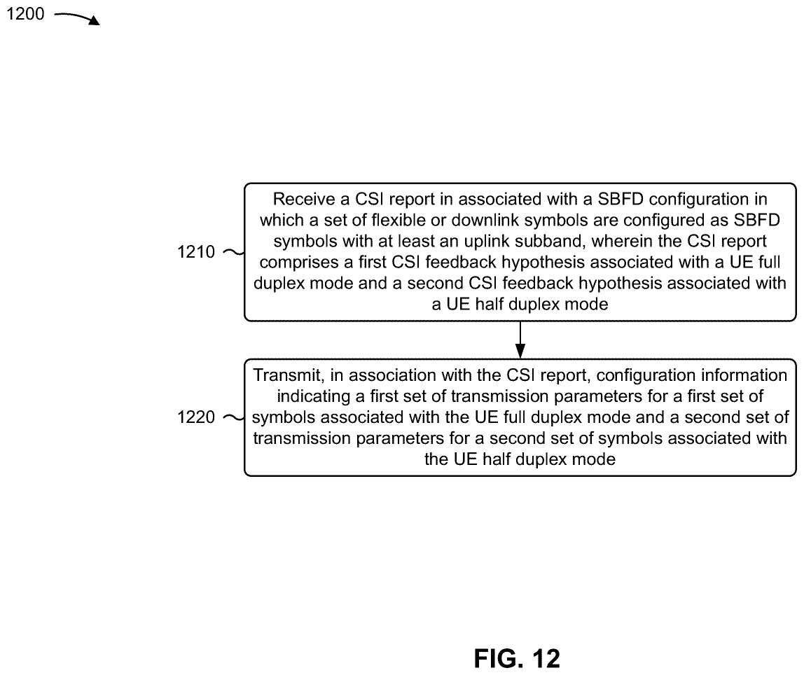

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with UE capability for switching between full duplex mode and half duplex mode, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, process 1100 of FIG. 11, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, a UE (e.g., the UE 120) includes means for transmitting UE capability information associated with an SBFD configuration in which a set of flexible symbols are configured as SBFD symbols with a subband, wherein the UE capability information comprises a UE capability indication associated with switching between a UE full duplex mode and a UE half duplex mode; and/or means for communicating in association with the UE capability indication.

In some aspects, a UE (e.g., the UE 120) includes means for transmitting a CSI report associated with an SBFD configuration in which a set of flexible symbols are configured as SBFD symbols with an uplink subband, wherein the CSI report comprises a first CSI feedback hypothesis associated with a UE full duplex mode and a second CSI feedback hypothesis associated with a UE half duplex mode; and/or means for receiving, in association with the CSI report, configuration information indicating a first set of transmission parameters for a first set of symbols associated with the UE full duplex mode and a second set of transmission parameters for a second set of symbols associated with the UE half duplex mode. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving UE capability information associated with an SBFD configuration in which a set of flexible symbols are configured as SBFD symbols with a subband, wherein the UE capability information comprises a UE capability indication associated with switching between a UE full duplex mode and a UE half duplex mode; and/or means for communicating in association with the UE capability indication. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network node (e.g., the network node 110) includes means for receiving a CSI report in associated with an SBFD configuration in which a set of flexible symbols are configured as SBFD symbols with an uplink subband, wherein the CSI report comprises a first CSI feedback hypothesis associated with a UE full duplex mode and a second CSI feedback hypothesis associated with a UE half duplex mode; and/or means for transmitting, in association with the CSI report, configuration information indicating a first set of transmission parameters for a first set of symbols associated with the UE full duplex mode and a second set of transmission parameters for a second set of symbols associated with the UE half duplex mode. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

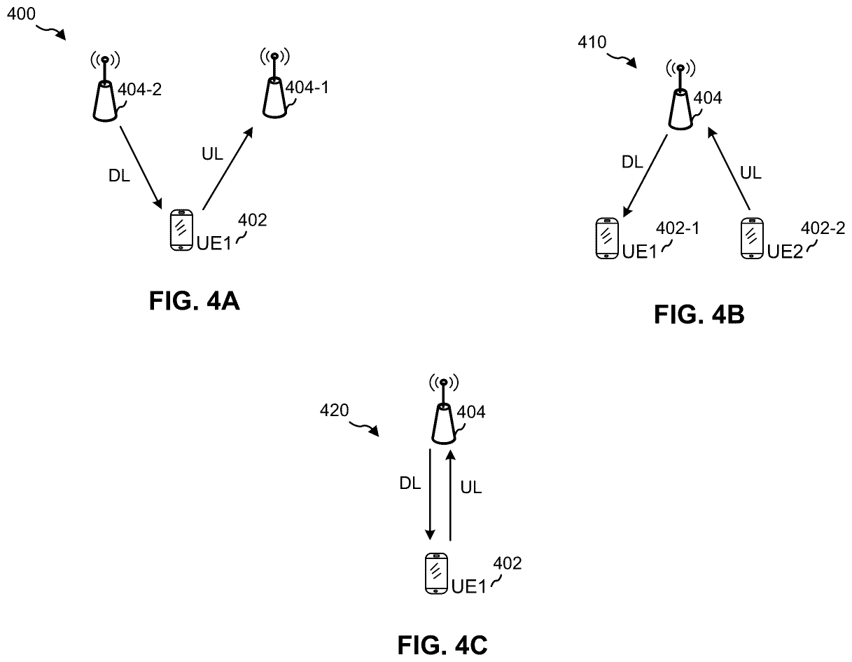

FIGS. 4A-4C are diagrams illustrating examples 400, 410, 420 of full duplex (FD) communication in accordance with the present disclosure. The example 400 of FIG. 4A includes a UE1 402 and two network nodes (e.g., transmission reception points (TRPs)) 404-1, 404-2, where the UE1 402 is sending UL transmissions to the network node 404-1 and is receiving DL transmissions from the network node 404-2. In the example 400 of FIG. 4A, FD is enabled for the UE1 402, but not for the network nodes 404-1, 404-2. The example 410 of FIG. 4B includes two UEs, shown as UE1 402-1 and UE2 402-2, and a network node 404, where the UE1 402-1 is receiving a DL transmission from the network node 404 and the UE2 402-2 is transmitting an UL transmission to the network node 404. In the example 410 of FIG. 4B, FD is enabled for the network node 404, but not for the UE1 402-1 and the UE2 402-2. The example 420 of FIG. 4C includes a UE1 402 and a network node 404, where the UE1 402 is receiving a DL transmission from the network node 404 and the UE1 402 is transmitting an UL transmission to the network node 404. In the example 420 of FIG. 4C, FD is enabled for both the UE1 402 and the network node 404.

As indicated above, FIGS. 4A-4C are provided as one or more examples. Other examples may differ from what is described with regard to FIGS. 4A-4C.

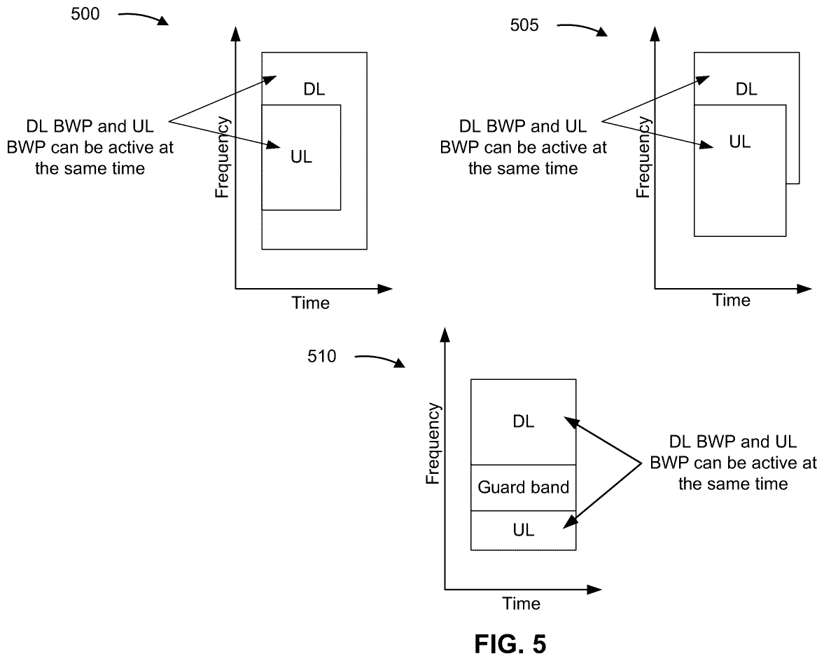

FIG. 5 is a diagram illustrating examples 500, 505, and 510 of FD communication in a wireless network, in accordance with the present disclosure. As shown in FIG. 5, examples 500 and 505 show examples of in-band full-duplex (IBFD) communication (which may also be referred to herein as “full duplex” (FD) communication). In FD, a UE may transmit an uplink communication to a network node and receive a downlink communication from the network node on the same time and frequency resources. As shown in example 500, in a first example of FD (referred to as “fully overlapping FD”), the time and frequency resources for uplink communication may fully overlap with the time and frequency resources for downlink communication. As shown in example 505, in a second example of FD (referred to as “partially overlapping FD”), the time and frequency resources for uplink communication may partially overlap with the time and frequency resources for downlink communication.

As further shown in FIG. 5, example 510 shows an example of SBFD communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing (TDD) band. In this case, the frequency resources used for downlink communication may be separated from the frequency resources used for uplink communication, in the frequency domain, by a guard band.

As indicated above, FIG. 5 is provided as an example. Other examples may differ from what is described with respect to FIG. 5.

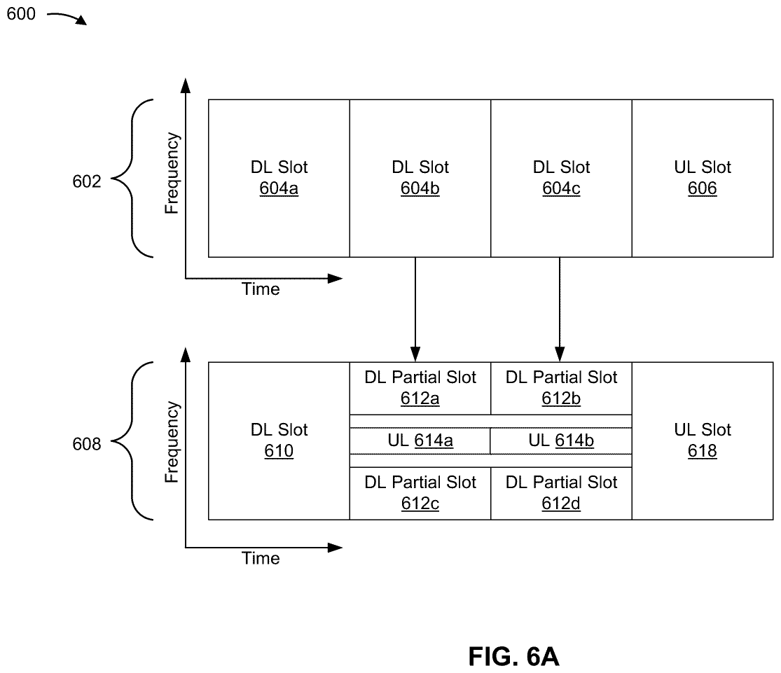

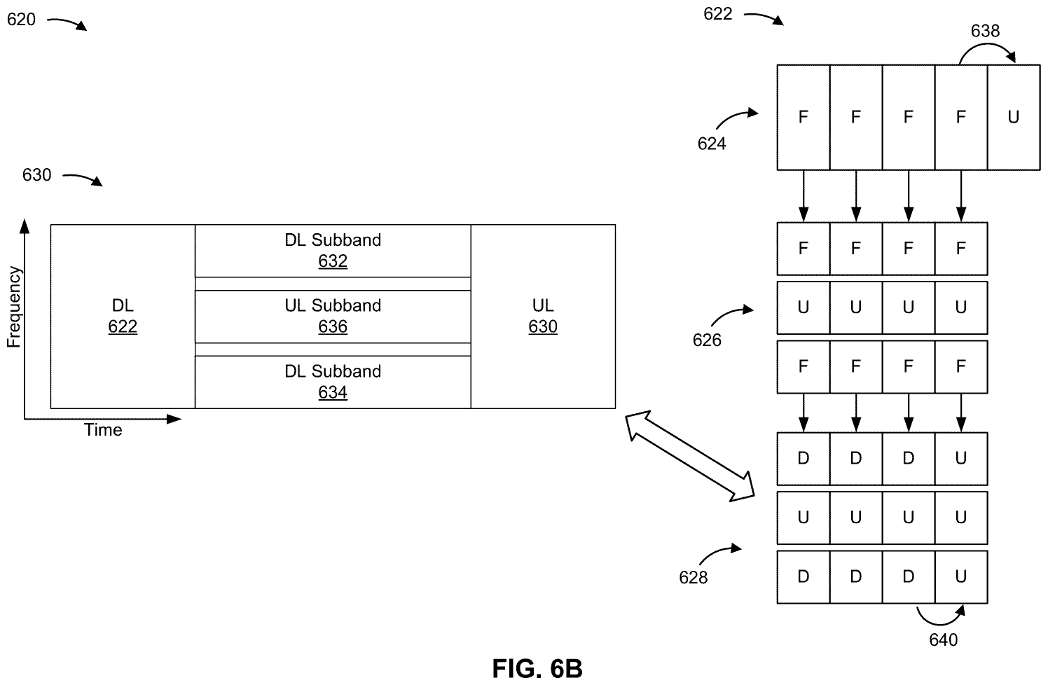

FIGS. 6A and 6B are diagrams illustrating examples associated with SBFD configurations, in accordance with the present disclosure.

FIG. 6A is a diagram illustrating an example 600 of SBFD activation, in accordance with the present disclosure. As shown in FIG. 6A, example 600 includes a first configuration 602. In some aspects, the first configuration 602 may indicate a first slot format pattern (sometimes called a TDD pattern) associated with a half-duplex mode or an FD mode. Each slot and/or portions thereof (e.g., symbols) may be scheduled and/or configured for use for an uplink (“UL”) communication, a downlink (“DL”) communication, or as flexible (“F”). A flexible slot may be used for either an uplink communication or a downlink communication. A resource configured and/or scheduled for use for an uplink communication is described herein as having an uplink (U) format. A resource configured and/or scheduled for use for a downlink communication is described herein as having a downlink (D) format. A resource configured and/or scheduled to include only flexible resources is described herein as having a flexible (F) format. All symbols within each slot may all be assigned alike (e.g., all “UL,” all “DL,” or all “F”), or else the slot may include multiple symbol assignment types. The first slot format pattern may include a quantity of downlink slots (e.g., three downlink slots 604a, 604b, and 604c, as shown), a quantity of flexible slots (not shown), and/or a quantity of uplink slots (e.g., one uplink slot 606, as shown). The first slot format pattern may repeat over time. In some aspects, a network node 110 may indicate the first slot format pattern to a UE 120 using one or more slot format indicators. A slot format indicator, for a slot, may indicate whether that slot is an uplink slot, a downlink slot, or a flexible slot, among other examples.

A network node 110 may instruct (e.g., using an indication, such as an RRC message, a MAC control element MAC-CE, or downlink control information (DCI)) a UE 120 to switch from the first configuration 602 to a second configuration 608. As an alternative, the UE 120 may indicate to the network node 110 that the UE 120 is switching from the first configuration 602 to the second configuration 608. The second configuration 608 may indicate a second slot format pattern that repeats over time, similar to the first slot format pattern. In any of the aspects described above, the UE 120 may switch from the first configuration 602 to the second configuration 608 during a time period (e.g., a quantity of symbols and/or an amount of time (e.g., in ms)) based at least in part on an indication received from the network node 110 (e.g., before switching back to the first configuration 602). During that time period, the UE 120 may communicate using the second slot format pattern, and then may revert to using the first slot format pattern after the end of the time period. The time period may be indicated by the network node 110 (e.g., in the instruction to switch from the first configuration 602 to the second configuration 608, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by u and associated with corresponding SCSs) with corresponding time periods for switching configurations.

In example 600, the second slot format pattern includes a downlink slot 610, an uplink slot 618, and two SBFD slots in place of what were downlink slots in the first slot format pattern. In example 600, each SBFD slot includes a partial slot (e.g., a portion or sub-band of a frequency allocated for use by the network node 110 and the UE 120) for downlink (e.g., partial slots 612a, 612b, 612c, and 612d, as shown) and a partial slot for uplink (e.g., partial slots 614a and 614b, as shown). Accordingly, the UE 120 may operate using the second slot format pattern to transmit an uplink communication in an earlier slot (e.g., the second slot in sequence, shown as partial UL slot 614a) as compared to using the first slot format pattern (e.g., the fourth slot in sequence, shown as UL slot 606). Other examples may include additional or alternative changes. For example, the second configuration 608 may indicate an SBFD slot in place of what was an uplink slot in the first configuration 602 (e.g., UL slot 606). In another example, the second configuration 608 may indicate a downlink slot or an uplink slot in place of what was an SBFD slot in the first configuration 602 (not shown in FIG. 6A). In yet another example, the second configuration 608 may indicate a downlink slot or an uplink slot in place of what was an uplink slot or a downlink slot, respectively, in the first configuration 602. “SBFD slot” refers to a slot in which an SBFD format is used.

An SBFD format may include a slot format in which FD communication is supported (e.g., for both uplink and downlink communications), with one or more frequencies used for an uplink portion of the slot being separated from one or more frequencies used for a downlink portion of the slot by a guard band. In some examples, the SBFD format may include a single uplink portion and a single downlink portion separated by a guard band. In some examples, the SBFD format may include multiple downlink portions and a single uplink portion that is separated from the multiple downlink portions by respective guard bands (e.g., as shown in FIG. 6A). In some examples, an SBFD format may include multiple uplink portions and a single downlink portion that is separated from the multiple uplink portions by respective guard bands. In some examples, the SBFD format may include multiple uplink portions and multiple downlink portions, where each uplink portion is separated from a downlink portion by a guard band. In some examples, operating using an SBFD mode may include activating or using an FD mode in one or more slots based at least in part on the one or more slots having the SBFD format. A slot may support the SBFD mode if an uplink bandwidth part (BWP) and a downlink BWP are permitted to be or are simultaneously active in the slot in an SBFD fashion (e.g., with guard band separation).

By switching from the first configuration 602 to the second configuration 608, the network node 110 and the UE 120 may experience increased quality and/or reliability of communications. For example, the network node 110 and the UE 120 may experience increased throughput (e.g., using an FD mode), reduced latency (e.g., the UE 120 may be able to transmit an uplink and/or receive a downlink communication sooner using the second configuration 608 rather than the first configuration 602), and increased network resource utilization (e.g., by using both the downlink BWP and the uplink BWP simultaneously instead of only the downlink BWP or the uplink BWP).

FIG. 6B is a diagram showing an example 620 of SBFD operation in flexible symbols, in accordance with the present disclosure.

As shown by reference number 622, resources (e.g., slots and/or symbols) 624 may be semi-statically configured as flexible and, thus, may be later reconfigured for use for uplink or downlink communication. In some aspects, a common configuration parameter (e.g., tdd-UL-DL-ConfigurationCommon or similar) transmitted to all UEs in a cell defines a semi-static slot and/or symbol structure 626, including designating certain slots or symbols for use in uplink communication, downlink communication, or as flexible for use in either uplink or downlink communication. For example, the common configuration parameter may semi-statically configure slots and symbols to have an initial configuration. A dedicated configuration parameter (e.g., tdd-UL-DL-ConfigurationDedicated), which can be transmitted to a specific UE via a slot format indicator (SFI), may then be used to reconfigure the flexible slots and symbols as uplink or downlink slots and symbols to form an SBFD configuration 628. In some cases, for a remaining flexible slot or symbol (e.g., slots or symbols still configured as flexible after the reconfiguration due to the dedicated configuration parameter), the UE may monitor for physical downlink control channel (PDCCH) information, and determine whether a flexible slot or symbol should be configured as an uplink slot or symbol or a downlink slot or symbol based at least in part on an uplink and/or downlink resource allocation indicated by the PDCCH information. In some cases, the flexible slots or symbols may be dynamically changed by the network node via a DCI message or a similar message (which may be referred to as a UE-dedicated configuration).

Resources (e.g., slots and/or symbols, such as downlink or flexible slots and/or symbols) can be configured to have an SBFD format. A resource having an SBFD format includes one or more SBFD symbols. An SBFD symbol is a symbol with one or more sub-bands (referred to herein as SBFD sub-bands) that a network node (such as a gNB) can use or will use for SBFD operation. For SBFD operation within a TDD carrier, an SBFD sub-band may include 1 resource block, or a set of consecutive resource blocks, for a same transmission direction. In some aspects, for SBFD operation within a TDD carrier, an SBFD sub-band consists of 1 resource block, or a set of consecutive resource blocks, for a same transmission direction. In some aspects, “SBFD symbols” are defined as symbols with subbands that a gNB would use for SBFD operation. In some aspects, for SBFD operation within a TDD carrier, an SBFD subband consists of 1 resource block (RB) or a set of consecutive RBs for the same transmission direction.

An SBFD resource (that is, a resource having an SBFD format) may include one or more symbols and/or one or more slots. As mentioned above, an SBFD resource may include at least one uplink sub-band (that is, a sub-band used for uplink communication by a UE) and at least one downlink sub-band (that is, a sub-band used for downlink communication by a UE). As shown by reference number 630, the SBFD configuration 628 can include two non-contiguous downlink sub-bands 632 and 634 and one uplink sub-band 636. The two downlink sub-bands 632 and 634 can be used by a single UE, or by different UEs (e.g., a first UE for a first downlink sub-band 632 and a second UE for a second downlink sub-band 634). As mentioned above, a sub-band may include one or multiple consecutive resource blocks associated with a transmission direction. Example 620 may illustrate a symbol having an SBFD format (e.g., a symbol in which there is a set of resource blocks comprising at least one downlink sub-band and a set of resource blocks comprising at least one uplink sub-band), a slot having an SBFD format (e.g., a slot in which there is at least one downlink sub-band and at least one uplink sub-band), or another time resource having an SBFD format.

In some aspects, for SBFD operation in a symbol configured as flexible in TDD-UL-DL-ConfigCommon, for an SBFD aware UE, uplink transmissions within the uplink subband may be allowed in the symbol, and the resource blocks (RBs) outside the uplink subband can be used as either uplink or downlink (excluding guardbands if used) in the symbol from the network's perspective, and the transmission direction for all of those RBs may be the same. In some cases, uplink transmissions are within active uplink BWPs and downlink receptions are within active downlink BWPs in the symbol. For all RBs outside the uplink subband, the UE may not be able to use separate RBs for downlink and uplink simultaneously.

As indicated above, FIGS. 6A and 6B are provided as examples. Other examples may differ from what is described with respect to FIGS. 6A and 6B.

In some cases, a UE capable of FD and/or SBFD may be configured to communicate with one or more network nodes, cells, and/or TRPs capable of SBFD to further enhance system capacity, UL coverage, and to reduce latency. In other cases, an SBFD UE can communicate with two half duplex (HD) cells and/or TRPs (e.g., some cells with low capability could still implement in an HD cell mode). In some cases, two or more communication modes can be implemented in different time periods. To facilitate flexibility and efficiency in resource allocation and power consumption from the perspective of the UE and/or the network node, being able to transition between communication modes may be useful.

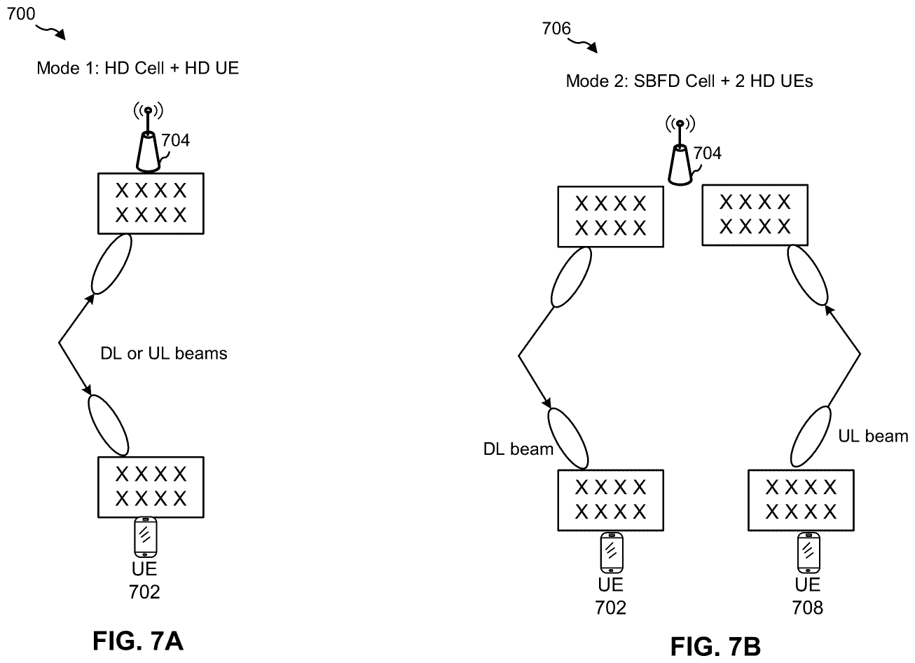

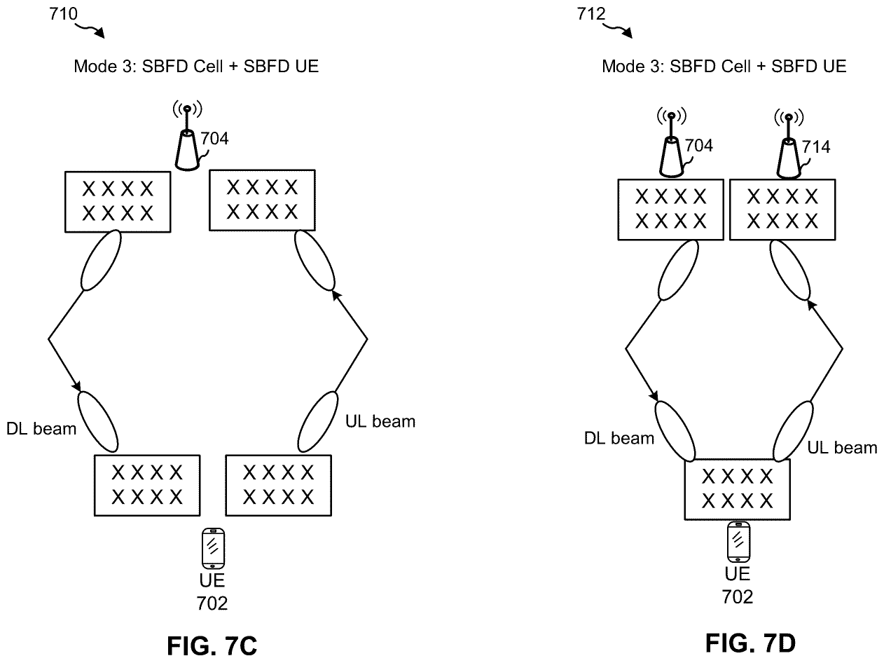

FIGS. 7A-7D are diagrams illustrating examples of various communication modes in accordance with the present disclosure. FIG. 7A illustrates an example 700 of a first communication mode (“Mode 1”) in which an HD UE 702 communicates with a network node 704 that provides an HD cell. In a time period, either the UE 702 may receive a communication from the network node 704 or transmit a communication to the network node 704. FIG. 7B illustrates an example 706 of a second communication mode (“Mode 2”) in which a network node 704 provides an SBFD cell that communicates with two HD UEs 702 and 708. In a time period, the UE 702 may receive a communication from the network node 704 simultaneously with the UE 708 transmitting a communication to the network node 704.

FIG. 7C illustrates an example 710 of a third communication mode (“Mode 3”) in which an SBFD UE 702 communicates with a network node 704 that provides an SBFD cell. During a time period, the UE 702 may simultaneously transmit (e.g., via an UL subband) a communication to the network node 704 and receive (e.g., via a DL subband) a communication from the network node 704. FIG. 7D illustrates an example 712 of a fourth communication mode (“Mode 4”) in which an SBFD UE 702 communicates with one or more network nodes 704, 714 via two HD cells and/or HD TRPs, respectively. During a time period, the UE 702 may receive a communication from the first TRP 704 (and/or via the first cell) and transmit a communication to the second TRP 714 (and/or via the second cell). In some cases, a fifth communication mode (“Mode 5”) may be implemented in which an FD UE communicates with one or more TRPs and/or via one or more cells. The FD UE may be configured for partially overlapping FD and/or fully overlapping FD.

For SBFD symbols configured on flexible symbols, one alternative can be to configure the symbols as F/U/F. In some cases, the RBs outside the uplink subband can be scheduled as D (D/U/D) or can be scheduled as U (U/U/U). In this case, even the F symbols configured with uplink subband as SBFD symbols can be SBFD symbols or U symbols. For an SBFD capable UE supporting UE FD and HD modes, a switching between SBFD UE and HD UE could be required on the F symbols configured with UL subband (e.g., a UL filter switching between FD and HD symbols). For example, as shown in FIG. 6B, a potential switching point 638 may exist between an F symbol and a U symbol outside of the subband. Other switching points 640 may exist between symbols within the subbands.

Some aspects of the techniques and apparatuses described herein may include defining UE capabilities related to switching between FD symbols and HD symbols. In some aspects, a network may configure and/or schedule resources based on the UE capabilities, which may facilitate support for different communication modes at a UE. In some aspects, a UE's capabilities associated with switching between HD and FD communications may be indicated based on classifications. In some aspects, different UE capabilities may be defined for different types of symbols. For example, a UE may have a first set of capabilities associated with F symbols and a second set of capabilities associated with semi-static configured SBFD and non-SBFD symbols. In this way, some aspects may facilitate transitioning a UE between communication modes for different time periods, thereby enhancing flexibility of configuration of HD and/or FD communications between one or more UEs and one or more network nodes, allowing for improved network efficiency of resource allocation and/or improved device efficiency in terms of power consumption.

In some cases, if an SBFD UE operates in a UE SBFD mode in some SBFD symbols/slots and operates in an HD mode with the network node in an SBFD mode in some other SBFD symbols/slots, then the same semi-static time and DL/UL subband network node SBFD configuration in an SBFD symbol may not be enough to differentiate the two different UE modes. In some cases, a UE may have different antenna configurations for the two modes. For example, in some cases, the UE can use a full antenna array for an HD mode; however, the UE may split the full antenna array into two separate antenna arrays/panels for a UE SBFD mode. For an SBFD UE mode, the network node may need to configure the UE with two TCI states for paired DL and UL transmissions considering system information (SI) conditions, which may be different from the best RSRP TCI state in a HD UE mode. For example, in some cases, operation parameters (e.g., UL transmit power, a modulation and coding scheme (MCS), a DL beam and/or a UL beam, among other examples) could be different. The RF components of the network node may be retuned for two different modes (e.g., if an additional UE filter is used for UE SBFD mode (e.g., for SI mitigation)). In some cases, UE SBFD may require a different subband, frequency pattern, and/or guard band compared with network node SBF (e.g., a switching delay may be used to support this feature). As described above, a UE spatial configuration may be different between a UE FD mode and a UE HD mode.

Accordingly, in some aspects, the UE capability information may include a spatial configuration switching capability indication. In some aspects, based on the spatial configuration switching capability indication, the network node may transmit a spatial configuration switch indication. In some aspects, a spatial configuration switch rule may be indicated by a wireless communication standard and, therefore, maintained in one or more memories of the UE. In this way, some aspects may enable a network node to distinguish between a UE HD mode and a UE FD mode and, thereby, reconfigure transmission parameters and/or network node components to more efficiently and accurately communicate with the UE. As a result, some aspects may positively impact network performance.

As indicated above, FIGS. 7A-7D are provided as examples. Other examples may differ from what is described with respect to FIGS. 7A-7D.

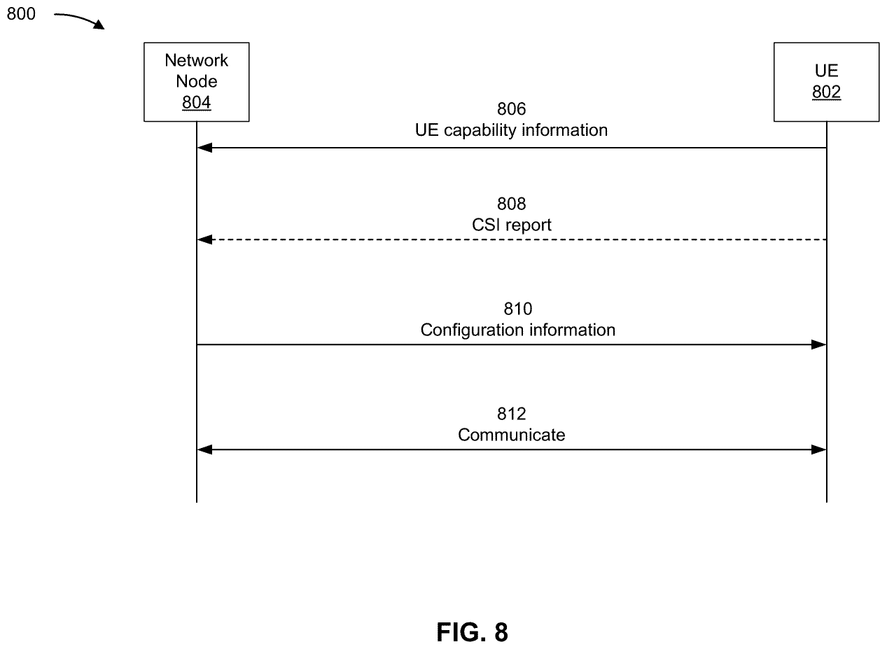

FIG. 8 is a diagram illustrating an example 800 associated with UE capabilities for switching between FD mode and HD mode, in accordance with the present disclosure. As shown in FIG. 8, a UE 802 and a network node 804 may communicate with one another. In some aspects, the UE 802 may be, be similar to, include, or be included in, the UE 702 and/or the UE 708 depicted in FIGS. 7A-7D; the UE1 402, the UE1 402-1, and/or the UE2 402-2 depicted in FIGS. 4A-4C; and/or the UE 120 depicted in FIGS. 1-3. In some aspects, the network node 804 may be, be similar to, include, or be included in, the TRP 704 and/or the TRP 714 depicted in FIGS. 7A-7D; the TRP 404, the TRP 404-1, and/or the TRP 404-2 depicted in FIGS. 4A-4C; the network node 110 depicted in FIGS. 1 and 2; and/or one or more components of the disaggregated base station architecture 300 depicted in FIG. 3.

As shown by reference number 806, the UE 802 may transmit, and the network node 804 may receive, UE capability information. In some aspects, the UE capability information may be associated with an SBFD configuration in which a set of flexible or downlink symbols are configured as SBFD symbols with an uplink (or downlink) subband. In some aspects, the UE capability information may include a UE capability indication associated with switching between a UE full duplex mode and a UE half duplex mode.

In some aspects, the UE capability information may be associated with two or more communication modes of a plurality of communication modes. The two or more communication modes may include at least one FD mode. The at least one FD mode may include at least one of an SBFD mode, a partial overlapping FD mode, or a fully overlapping FD mode. In some aspects, the two or more communication modes may include a first mode (e.g., Mode 1) in which the UE 802 comprises an HD UE and the network node 804 provides an HD cell. In the first mode, the UE 802 may communicate with the network node 804 in association with one communication direction (e.g., uplink or downlink) during a time period (e.g., a symbol or a slot). The two or more communication modes may include a second mode (e.g., Mode 2) in which the UE 802 may include a first HD UE of a plurality of HD UEs and the network node 804 may provide an SBFD cell. In the second mode, the UE 802 may communicate with the network node 804 in association with one communication direction during the time period. The two or more communication modes may include a third mode (e.g., Mode 3) in which the UE 802 includes an SBFD UE and the network node 804 provides an SBFD cell. In the third mode, the UE 802 may communicate with the network node 804 in association with two communication directions during the time period. The two or more communication modes may include a fourth mode (e.g., Mode 4) in which the UE 802 may include an SBFD UE and the network node 804 may provide an HD cell or transmission reception point (TRP) of a plurality of HD cells. In the fourth mode, the UE 802 may communicate via the cell or the TRP in association with a first communication direction during the time period and via an additional cell or an additional TRP in association with a second communication direction during the time period. The two or more communication modes may include a fifth communication mode (e.g., Mode 5) in which the UE 802 may include a partially overlapping FD UE and/or a fully overlapping FD UE.

In some aspects, the UE capability information may include a UE capability indication associated with switching between a UE full duplex mode and a UE half duplex mode. The UE capability indication may include at least one filter switching capability indication that is indicative of a classification of a plurality of potential classifications associated with the UE 802. In some aspects, each classification of the plurality of potential classifications may be associated with a filter capability of a plurality of filter capabilities. A first classification of the plurality of potential classifications may be associated with a first filter capability of the plurality of filter capabilities, and the first filter capability may indicate that the UE 802 supports only a fixed wideband filter. The fixed wideband filter may be associated with full duplex symbols and half duplex symbols.

In some aspects, a second classification of the plurality of potential classifications may be associated with a second filter capability of the plurality of filter capabilities. The second filter capability may indicate that the UE 802 supports an adaptive uplink filter only at a boundary between a semi-static configured SBFD time unit and a non-SBFD time unit. The semi-static configured SBFD time unit may include at least one of a first symbol or a first slot and the non-SBFD time unit may include at least one of a second symbol or a second slot. For example, the UE 802 may be configured for adapting an uplink filter only between semi-static configured SBFD and non-SBFD symbol/slot boundaries (e.g., between F and U). In this case, at least one SBFD symbols, no additional scheduling offset may be required to retune the filter. For example, the UE may communicate in the absence of a scheduling offset. In some aspects, an additional switching guard period (which may be provided via a scheduling offset) may be used only between SBFD and non-SBFD symbol types (e.g., between F/D and U).

In some aspects, a third classification of the plurality of potential classifications may be associated with a third filter capability of the plurality of filter capabilities, and the third filter capability may include the second filter capability and may indicate that the UE 802 supports filter adaptation across flexible or downlink symbols that are semi-statically configured as SBFD symbols. When an uplink bandwidth changes (e.g., from U/U/U to D/U/D or vice versa) on SBFD configured on F symbols, the UE 802 may need an additional scheduling offset for filter retuning.

In some aspects, the UE capability indication may include an indication that the UE 802 supports dynamic bandwidth switching. In some aspects, the UE may support only a default wideband filter. In some aspects, the UE 802 may support an uplink filter adaptation. In some aspects, the UE capability indication may be indicative of a failure of the UE 802 to support dynamic bandwidth switching. In some aspects, the UE capability indication may indicate that the UE 802 supports switching between a semi-static configured SBFD symbol and a non-SBFD symbol without a guard period. A filter may include, for example, any form of filter that can be applied to a transmitted or received signal, such as an interference filter. An uplink filter may be used for transmission by the UE 802. A downlink filter may be used for reception by the UE 802. A wideband filter may apply across an entire band (e.g., SBFD resource), whereas a narrowband filter may apply to a subset of a band (e.g., a subband of an SBFD resource, one or more resource blocks).

In some aspects, the UE capability indication may indicate that the UE 802 supports switching between a semi-static configured SBFD symbol and a non-SBFD symbol with a guard period. In some aspects, the UE capability indication may include a spatial configuration switching capability indication. In some aspects, the UE 802 may receive, from the network node 804, based on the spatial configuration switching capability indication, a spatial configuration switch indication. Receiving the spatial configuration switch indication may include receiving downlink control information (DCI) including the spatial configuration switch indication. In some aspects, a wireless communication standard may indicate a spatial configuration switch rule and therefore, the spatial configuration switch rule may be maintained in one or more memories of the UE 802 and/or the network node 804. A spatial configuration may include, for example, a TCI state, a QCL parameter, a spatial filter, one or more beam parameters, or the like.

In some aspects, the spatial configuration switching capability indication may be associated with a guard period for switching between the UE full duplex mode and the UE half duplex mode. The UE capability information may indicate a length of the guard period. An indication of a length of the guard period may be maintained in one or more memories of the network node 804. In some aspects, a length of the guard period may include a maximum value of a filter retuning latency value and a spatial configuration switching latency value.

As shown by reference number 808, the UE 802 may transmit, and the network node 804 may receive, a CSI report. The CSI report may be a periodic CSI report, an aperiodic CSI report, or a semi-persistent CSI report. In some aspects, the CSI report may be associated with an SBFD configuration in which a set of flexible or downlink symbols are configured as SBFD symbols with an uplink subband. A UE full duplex mode is a mode in which a UE communicates in full duplex, such as SBFD. A UE half duplex mode is a mode in which a UE communicates in half duplex, such as only uplink transmission at a given time or only downlink receptions at a given time.

In some aspects, the CSI report may include a first CSI feedback hypothesis associated with a UE full duplex mode and a second CSI feedback hypothesis associated with a UE half duplex mode. For example, in a single CSI report, a full duplex UE may report two hypotheses of CSI feedback: one hypothesis or set of hypotheses for full duplex mode, and one hypothesis or set of hypotheses for half duplex mode. A hypothesis may indicate a set of feedback (e.g., CQI, rank, PMI) corresponding to a particular configuration, mode, or state. In this context, a first hypothesis may indicate feedback derived assuming a UE full duplex mode, and a second hypothesis may indicate feedback derived using a UE half duplex mode.

As shown by reference number 810, the network node 804 may transmit, and the UE 802 may receive, configuration information. In some aspects, the configuration information may be associated with the two or more communication modes. In some aspects, the configuration information may be associated with the SBFD configuration in which the set of flexible or downlink symbols are configured as SBFD symbols within an uplink subband.

As shown by reference number 812, the UE 802 and the network node 804 may communicate with one another. For example, the UE 802 and the network node 804 may communicate with one another in association with the UE capability indication. In some aspects, communicating in association with the UE capability indication may include communicating, based on an uplink bandwidth changing between communication direction schemes associated with a set of flexible or downlink symbols configured as SBFD symbols, in association with a scheduling offset associated with a filter retuning operation. In some aspects, communicating in association with the UE capability indication may include the UE 802 transmitting, in accordance with a first uplink filter mode, a first communication in an uplink subband of an SBFD symbol of the set of flexible or downlink symbols configured as SBFD symbols. The UE 802 also may transmit, in accordance with a second uplink filter mode, a second communication in a full band uplink symbol and may transition, based on completing the transmitting the second communication, to the first uplink filter mode. For example, the UE 802 may transition autonomously to the first uplink filter mode. The first uplink filter mode may include a default filter mode. In some aspects, transitioning to the first uplink filter mode may include transmitting to the first uplink filter mode based on a default indication. The default indication may include at least one of an indication stored in one or more memories of the UE 802, an indication included in configuration information received by the UE 802, or an indication included in the UE capability information.

In some aspects, communicating in association with the UE capability indication may include transmitting, in accordance with a first uplink filter mode, a first communication in an uplink subband of an SBFD symbol of the set of flexible or downlink symbols configured as SBFD symbols. The UE 802 may transmit, in accordance with a second uplink filter mode, a second communication in a full band uplink symbol and may maintain, based on completing the transmitting the second communication, the second uplink filter mode. For example, the first uplink filter mode may include a latest filter mode. In some aspects, transitioning to the first uplink filter mode may include transitioning to the first uplink filter mode based on a default indication. The default indication may include at least one of an indication stored in one or more memories of the UE 802, an indication included in configuration information received by the UE 802, or an indication included in the UE capability information.

In some aspects, communicating in association with the UE capability indication may include transmitting uplink transmissions only scheduled within the uplink subband. In some aspects, transmitting the uplink transmissions may include transmitting the uplink transmissions in association with a default narrowband uplink filter.

As indicated above, FIG. 8 is provided as an example. Other examples may differ from what is described with respect to FIG. 8.

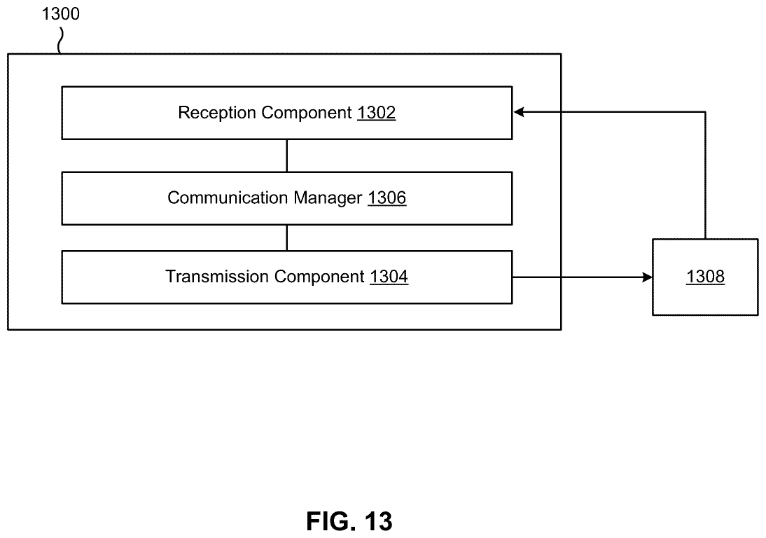

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with capabilities for switching filters or spatial configurations between SBFD and non-SBFD resources.

As shown in FIG. 9, in some aspects, process 900 may include transmitting UE capability information associated with an SBFD configuration, wherein the UE capability information comprises a UE capability indication related to at least one of a filter switching capability or a spatial configuration switching capability associated with switching between a UE full duplex mode and a UE half duplex mode (block 910). For example, the UE (e.g., using transmission component 1304 and/or communication manager 1306, depicted in FIG. 13) may transmit UE capability information associated with an SBFD configuration in which a set of flexible or downlink symbols are configured as SBFD symbols with at least an uplink subband. The UE capability information may comprise a UE capability indication related to at least one of a filter switching capability or a spatial configuration switching capability associated with switching between a UE full duplex mode and a UE half duplex mode, as described above.

As further shown in FIG. 9, in some aspects, process 900 may include communicating in association with the UE capability indication (block 920). For example, the UE (e.g., using reception component 1302, transmission component 1304, and/or communication manager 1306, depicted in FIG. 13) may communicate in association with the UE capability indication, as described above.

Process 900 may include additional aspects, such as any single aspect or any combination of aspects described below and/or in connection with one or more other processes described elsewhere herein.

In a first aspect, the filter switching capability indication is indicative of a classification of a plurality of potential classifications associated with the UE.

In a second aspect, alone or in combination with the first aspect, each classification of the plurality of potential classifications is associated with a filter capability of a plurality of filter capabilities.

In a third aspect, alone or in combination with one or more of the first and second aspects, a first classification of the plurality of potential classifications is associated with a first filter capability of the plurality of filter capabilities, and wherein the first filter capability indicates that the UE supports only a fixed wideband filter.

In a fourth aspect, alone or in combination with one or more of the first through third aspects, the fixed wideband filter is associated with subband full duplex symbols and half duplex symbols.

In a fifth aspect, alone or in combination with one or more of the first through fourth aspects, the fixed wideband filter is at least one of an uplink filter or a downlink filter.

In a sixth aspect, alone or in combination with one or more of the first through fifth aspects, a second classification of the plurality of potential classifications is associated with a second filter capability of the plurality of filter capabilities, and wherein the second filter capability indicates that the UE supports an adaptive uplink filter or an adaptive downlink filter only at a boundary between a semi-static configured SBFD time unit and a non-SBFD time unit.

In a seventh aspect, alone or in combination with one or more of the first through sixth aspects, the semi-static configured SBFD time unit comprises at least one of a first symbol or a first slot and wherein the non-SBFD time unit comprises at least one of a second symbol or a second slot.

In an eighth aspect, alone or in combination with one or more of the first through seventh aspects, a third classification of the plurality of potential classifications is associated with a third filter capability of the plurality of filter capabilities, and wherein the third filter capability comprises the second filter capability and indicates that the UE supports filter adaptation across flexible symbols that are semi-statically configured as SBFD symbols.

In a ninth aspect, alone or in combination with one or more of the first through eighth aspects, the SBFD symbols include one or more resources configurable as uplink or downlink resources, and wherein the one or more resources can be configured as an uplink resource in a first symbol of the SBFD symbols and a downlink resource in a second symbol of the SBFD symbols.

In a tenth aspect, alone or in combination with one or more of the first through ninth aspects, communicating in association with the UE capability indication comprises communicating, based on an uplink bandwidth changing between communication direction schemes associated with the set of flexible or downlink symbols configured as SBFD symbols, in association with a scheduling offset associated with a filter retuning operation.

In an eleventh aspect, alone or in combination with one or more of the first through tenth aspects, communicating in association with the UE capability indication comprises transmitting, in accordance with a first uplink filter mode, a first communication in an uplink subband of an SBFD symbol of the set of flexible or downlink symbols configured as SBFD symbols, transmitting, in accordance with a second uplink filter mode, a second communication in a full band uplink symbol, and transitioning, after completing the transmitting the second communication, to the first uplink filter mode.

In a twelfth aspect, alone or in combination with one or more of the first through eleventh aspects, the first uplink filter mode comprises a default filter mode.

In a thirteenth aspect, alone or in combination with one or more of the first through twelfth aspects, transitioning to the first uplink filter mode comprises transitioning to the first uplink filter mode based on a default indication, wherein the default indication comprises at least one of an indication stored in one or more memories of the UE, an indication included in configuration information received by the UE, or an indication included in the UE capability information.

In a fourteenth aspect, alone or in combination with one or more of the first through thirteenth aspects, communicating in association with the UE capability indication comprises receiving, in accordance with a first downlink filter mode, a first communication in a downlink subband of an SBFD symbol of the set of flexible or downlink symbols configured as SBFD symbols, receiving, in accordance with a second uplink filter mode, a second communication in a full band downlink symbol, and transitioning, after completing the transmitting the second communication, to the first downlink filter mode.

In a fifteenth aspect, alone or in combination with one or more of the first through fourteenth aspects, the first downlink filter mode comprises a default filter mode.

In a sixteenth aspect, alone or in combination with one or more of the first through fifteenth aspects, transitioning to the first downlink filter mode comprises transitioning to the first downlink filter mode based on a default indication, wherein the default indication comprises at least one of an indication stored in one or more memories of the UE, an indication included in configuration information received by the UE, or an indication included in the UE capability information.

In a seventeenth aspect, alone or in combination with one or more of the first through sixteenth aspects, communicating in association with the UE capability indication comprises transmitting, in accordance with a first uplink filter mode, a first communication in an uplink subband of an SBFD symbol of the set of flexible or downlink symbols configured as SBFD symbols, transmitting, in accordance with a second uplink filter mode, a second communication in a full band uplink symbol, and maintaining, after completing the transmitting the second communication, the second uplink filter mode.

In an eighteenth aspect, alone or in combination with one or more of the first through seventeenth aspects, the first uplink filter mode comprises a latest filter mode.

In a nineteenth aspect, alone or in combination with one or more of the first through eighteenth aspects, transitioning to the first uplink filter mode comprises transitioning to the first uplink filter mode based on a default indication, wherein the default indication comprises at least one of an indication stored in one or more memories of the UE, an indication included in configuration information received by the UE, or an indication included in the UE capability information.

In a twentieth aspect, alone or in combination with one or more of the first through nineteenth aspects, communicating in association with the UE capability indication comprises receiving, in accordance with a first downlink filter mode, a first communication in a downlink subband of an SBFD symbol of the set of flexible or downlink symbols configured as SBFD symbols, receiving, in accordance with a second downlink filter mode, a second communication in a full band downlink symbol, and maintaining, after completing the transmitting the second communication, the second downlink filter mode.

In a twenty-first aspect, alone or in combination with one or more of the first through twentieth aspects, the first downlink filter mode comprises a latest filter mode.

In a twenty-second aspect, alone or in combination with one or more of the first through twenty-first aspects, transitioning to the first downlink filter mode comprises transitioning to the first downlink filter mode based on a default indication, wherein the default indication comprises at least one of an indication stored in one or more memories of the UE, an indication included in configuration information received by the UE, or an indication included in the UE capability information.

In a twenty-third aspect, alone or in combination with one or more of the first through twenty-second aspects, the UE capability indication comprises an indication that the UE supports dynamic bandwidth switching.

In a twenty-fourth aspect, alone or in combination with one or more of the first through twenty-third aspects, the UE supports only a default wideband filter.

In a twenty-fifth aspect, alone or in combination with one or more of the first through twenty-fourth aspects, the UE supports uplink or downlink filter adaptation.

In a twenty-sixth aspect, alone or in combination with one or more of the first through twenty-fifth aspects, the UE capability indication is indicative of a failure of the UE to support dynamic bandwidth switching.

In a twenty-seventh aspect, alone or in combination with one or more of the first through twenty-sixth aspects, communicating in association with the UE capability indication comprises transmitting uplink transmissions only scheduled within the uplink subband or receiving downlink transmissions only scheduled within a downlink sub-band.

In a twenty-eighth aspect, alone or in combination with one or more of the first through twenty-seventh aspects, transmitting the uplink transmissions comprises transmitting the uplink transmissions in association with a default narrowband uplink filter.

In a twenty-ninth aspect, alone or in combination with one or more of the first through twenty-eighth aspects, receiving the downlink transmissions comprises receiving the downlink transmissions in association with a default narrowband downlink filter.

In a thirtieth aspect, alone or in combination with one or more of the first through twenty-ninth aspects, the UE capability indication indicates that the UE supports switching between a semi-static configured SBFD symbol and a non-SBFD symbol without a guard period.

In a thirty-first aspect, alone or in combination with one or more of the first through thirtieth aspects, the UE capability indication indicates that the UE supports switching between a semi-static configured SBFD symbol and a non-SBFD symbol with a guard period.

In a thirty-second aspect, alone or in combination with one or more of the first through thirty-first aspects, the UE capability indication comprises the spatial configuration switching capability.

In a thirty-third aspect, alone or in combination with one or more of the first through thirty-second aspects, process 900 includes receiving, based on the spatial configuration switching capability indication, a spatial configuration switch indication.

In a thirty-fourth aspect, alone or in combination with one or more of the first through thirty-third aspects, receiving the spatial configuration switch indication comprises receiving downlink control information comprising the spatial configuration switch indication.

In a thirty-fifth aspect, alone or in combination with one or more of the first through thirty-fourth aspects, a spatial configuration switch rule is maintained in one or more memories of the UE.

In a thirty-sixth aspect, alone or in combination with one or more of the first through thirty-fifth aspects, the spatial configuration switching capability indication is associated with a guard period for switching between the UE full duplex mode and the UE half duplex mode.

In a thirty-seventh aspect, alone or in combination with one or more of the first through thirty-sixth aspects, the UE capability information indicates a length of the guard period.

In a thirty-eighth aspect, alone or in combination with one or more of the first through thirty-seventh aspects, an indication of a length of the guard period is maintained in one or more memories of a network node.

In a thirty-ninth aspect, alone or in combination with one or more of the first through thirty-eighth aspects, a length of the guard period comprises a maximum value of a filter retuning latency value and a spatial configuration switching latency value.

In a fortieth aspect, alone or in combination with one or more of the first through thirty-ninth aspects, the spatial configuration switching capability is associated with switching between a first spatial configuration for the UE full duplex mode and a second spatial configuration for the UE half duplex mode.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with capabilities for switching filters or spatial configurations between SBFD and non-SBFD resources.

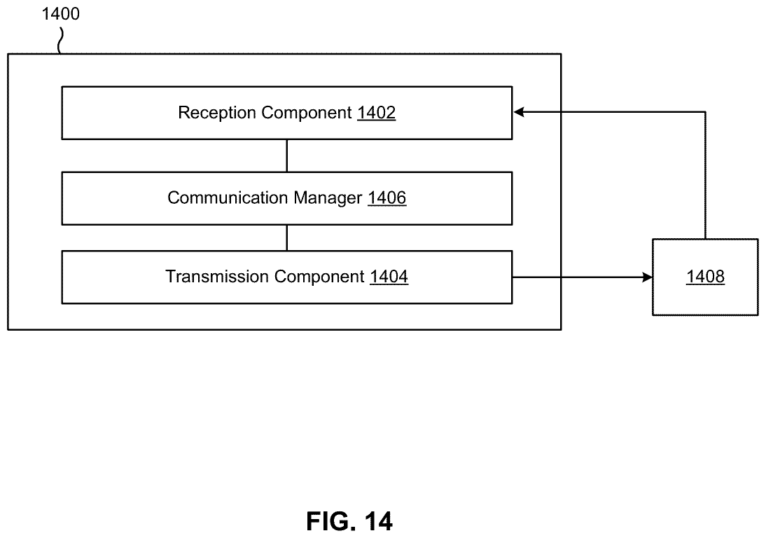

As shown in FIG. 10, in some aspects, process 1000 may include receiving, from a UE, UE capability information associated with an SBFD configuration, wherein the UE capability information comprises a UE capability indication related to at least one of a filter switching capability or a spatial configuration switching capability associated with switching between a UE full duplex mode and a UE half duplex mode (block 1010). For example, the network node (e.g., using reception component 1402 and/or communication manager 1406, depicted in FIG. 14) may receive, from a UE, UE capability information associated with an SBFD configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode, as described above.

As further shown in FIG. 10, in some aspects, process 1000 may include communicating in association with the UE capability indication (block 1020). For example, the network node (e.g., using reception component 1402, transmission component 1404, and/or communication manager 1406, depicted in FIG. 14) may communicate in association with the UE capability indication, as described above.

Process 1000 may include additional aspects, such as any single aspect or any combination of aspects described below and/or in connection with one or more other processes described elsewhere herein.

In a first aspect, the filter switching capability indication is indicative of a classification of a plurality of potential classifications associated with the UE.

In a second aspect, alone or in combination with the first aspect, each classification of the plurality of potential classifications is associated with a filter capability of a plurality of filter capabilities.

In a third aspect, alone or in combination with one or more of the first and second aspects, a first classification of the plurality of potential classifications is associated with a first filter capability of the plurality of filter capabilities, and wherein the first filter capability indicates that the UE supports only a fixed wideband filter.

In a fourth aspect, alone or in combination with one or more of the first through third aspects, the fixed wideband filter is associated with subband full duplex symbols and half duplex symbols.

In a fifth aspect, alone or in combination with one or more of the first through fourth aspects, the fixed wideband filter is at least one of an uplink filter or a downlink filter.

In a sixth aspect, alone or in combination with one or more of the first through fifth aspects, a second classification of the plurality of potential classifications is associated with a second filter capability of the plurality of filter capabilities, and wherein the second filter capability indicates that the UE supports an adaptive uplink filter or an adaptive downlink filter only at a boundary between a semi-static configured SBFD time unit and a non-SBFD time unit.

In a seventh aspect, alone or in combination with one or more of the first through sixth aspects, the semi-static configured SBFD time unit comprises at least one of a first symbol or a first slot and wherein the non-SBFD time unit comprises at least one of a second symbol or a second slot.

In an eighth aspect, alone or in combination with one or more of the first through seventh aspects, a third classification of the plurality of potential classifications is associated with a third filter capability of the plurality of filter capabilities, and wherein the third filter capability comprises the second filter capability and indicates that the UE supports filter adaptation across flexible symbols that are semi-statically configured as SBFD symbols.

In a ninth aspect, alone or in combination with one or more of the first through eighth aspects, the SBFD symbols include one or more resources configurable as uplink or downlink resources, and wherein the one or more resources can be configured as an uplink resource in a first symbol of the SBFD symbols and a downlink resource in a second symbol of the SBFD symbols.

In a tenth aspect, alone or in combination with one or more of the first through ninth aspects, communicating in association with the UE capability indication comprises communicating, based on an uplink bandwidth changing between communication direction schemes associated with the set of flexible or downlink symbols configured as SBFD symbols, in association with a scheduling offset associated with a filter retuning operation.

In an eleventh aspect, alone or in combination with one or more of the first through tenth aspects, the UE capability indication comprises an indication that the UE supports dynamic bandwidth switching.

In a twelfth aspect, alone or in combination with one or more of the first through eleventh aspects, the UE capability indication is indicative of a failure of the UE to support dynamic bandwidth switching.

In a thirteenth aspect, alone or in combination with one or more of the first through twelfth aspects, communicating in association with the UE capability indication comprises receiving uplink transmissions only scheduled within the uplink subband or transmitting downlink transmissions only scheduled within a downlink sub-band.

In a fourteenth aspect, alone or in combination with one or more of the first through thirteenth aspects, the UE capability indication indicates that the UE supports switching between a semi-static configured SBFD symbol and a non-SBFD symbol without a guard period.

In a fifteenth aspect, alone or in combination with one or more of the first through fourteenth aspects, the UE capability indication indicates that the UE supports switching between a semi-static configured SBFD symbol and a non-SBFD symbol with a guard period.

In a sixteenth aspect, alone or in combination with one or more of the first through fifteenth aspects, the UE capability indication comprises the spatial configuration switching capability.

In a seventeenth aspect, alone or in combination with one or more of the first through sixteenth aspects, process 1000 includes transmitting, based on the spatial configuration switching capability indication, a spatial configuration switch indication.

In an eighteenth aspect, alone or in combination with one or more of the first through seventeenth aspects, transmitting the spatial configuration switch indication comprises transmitting downlink control information comprising the spatial configuration switch indication.

In a nineteenth aspect, alone or in combination with one or more of the first through eighteenth aspects, the spatial configuration switching capability indication is associated with a guard period for switching between the UE full duplex mode and the UE half duplex mode.

In a twentieth aspect, alone or in combination with one or more of the first through nineteenth aspects, the UE capability information indicates a length of the guard period.

In a twenty-first aspect, alone or in combination with one or more of the first through twentieth aspects, an indication of a length of the guard period is maintained in one or more memories of the network node.

In a twenty-second aspect, alone or in combination with one or more of the first through twenty-first aspects, a length of the guard period comprises a maximum value of a filter retuning latency value and a spatial configuration switching latency value.

In a twenty-third aspect, alone or in combination with one or more of the first through twenty-second aspects, the spatial configuration switching capability is associated with switching between a first spatial configuration for the UE full duplex mode and a second spatial configuration for the UE half duplex mode.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with capabilities for switching filters or spatial configurations between SBFD and non-SBFD resources.

As shown in FIG. 11, in some aspects, process 1100 may include transmitting a CSI report in associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode (block 1110). For example, the UE (e.g., using transmission component 1304 and/or communication manager 1306, depicted in FIG. 13) may transmit a CSI report in associated with a SBFD configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode, as described above.

As further shown in FIG. 11, in some aspects, process 1100 may include receiving, in association with the CSI report, configuration information indicating a first set of transmission parameters for a first set of symbols associated with the UE full duplex mode and a second set of transmission parameters for a second set of symbols associated with the UE half duplex mode (block 1120). For example, the UE (e.g., using reception component 1302 and/or communication manager 1306, depicted in FIG. 13) may receive, in association with the CSI report, configuration information indicating a first set of transmission parameters for a first set of symbols associated with the UE full duplex mode and a second set of transmission parameters for a second set of symbols associated with the UE half duplex mode, as described above.

Process 1100 may include additional aspects, such as any single aspect or any combination of aspects described below and/or in connection with one or more other processes described elsewhere herein.

In some aspects, the first CSI feedback hypothesis includes a set of feedback derived assuming the UE full duplex mode and the second CSI feedback hypothesis includes a set of feedback derived assuming the UE half duplex mode. Additionally, or alternatively, the CSI report may include at least one of a periodic CSI report, a semi-persistent CSI report, or an aperiodic CSI report.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with capabilities for switching filters or spatial configurations between SBFD and non-SBFD resources.

As shown in FIG. 12, in some aspects, process 1200 may include receiving a channel state information (CSI) report in associated with a subband full duplex (SBFD) configuration in which a set of flexible or downlink symbols are configured as SBFD symbols with at least an uplink subband, wherein the CSI report comprises a first CSI feedback hypothesis associated with a user equipment (UE) full duplex mode and a second CSI feedback hypothesis associated with a UE half duplex mode (block 1210). For example, the network node (e.g., using reception component 1402 and/or communication manager 1406, depicted in FIG. 14) may receive a channel state information (CSI) report in associated with a subband full duplex (SBFD) configuration in which a set of flexible or downlink symbols are configured as SBFD symbols with at least an uplink subband, wherein the CSI report comprises a first CSI feedback hypothesis associated with a user equipment (UE) full duplex mode and a second CSI feedback hypothesis associated with a UE half duplex mode, as described above.

As further shown in FIG. 12, in some aspects, process 1200 may include transmitting, in association with the CSI report, configuration information indicating a first set of transmission parameters for a first set of symbols associated with the UE full duplex mode and a second set of transmission parameters for a second set of symbols associated with the UE half duplex mode (block 1220). For example, the network node (e.g., using transmission component 1404 and/or communication manager 1406, depicted in FIG. 14) may transmit, in association with the CSI report, configuration information indicating a first set of transmission parameters for a first set of symbols associated with the UE full duplex mode and a second set of transmission parameters for a second set of symbols associated with the UE half duplex mode, as described above.

Process 1200 may include additional aspects, such as any single aspect or any combination of aspects described below and/or in connection with one or more other processes described elsewhere herein.

In some aspects, the first CSI feedback hypothesis includes a set of feedback derived assuming the UE full duplex mode and the second CSI feedback hypothesis includes a set of feedback derived assuming the UE half duplex mode. Additionally, or alternatively, the CSI report may include at least one of a periodic CSI report, a semi-persistent CSI report, or an aperiodic CSI report.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

In some aspects, the apparatus 1300 may be configured to perform one or more operations described herein in connection with FIG. 8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit UE capability information associated with an SBFD configuration in which a set of flexible symbols are configured as SBFD symbols with a subband, wherein the UE capability information comprises a UE capability indication associated with switching between a UE full duplex mode and a UE half duplex mode. The reception component 1302 and/or the transmission component 1304 may communicate in association with the UE capability indication.

The reception component 1302 may receive, based on the spatial configuration switching capability indication, a spatial configuration switch indication.

The transmission component 1304 may transmit a CSI report associated with an SBFD configuration in which a set of flexible symbols are configured as SBFD symbols with an uplink subband, wherein the CSI report comprises a first CSI feedback hypothesis associated with a UE full duplex mode and a second CSI feedback hypothesis associated with a UE half duplex mode. The reception component 1302 may receive, in association with the CSI report, configuration information indicating a first set of transmission parameters for a first set of symbols associated with the UE full duplex mode and a second set of transmission parameters for a second set of symbols associated with the UE half duplex mode.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIG. 8. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive UE capability information associated with an SBFD configuration in which a set of flexible symbols are configured as SBFD symbols with a subband, wherein the UE capability information comprises a UE capability indication associated with switching between a UE full duplex mode and a UE half duplex mode. The reception component 1402 and/or the transmission component 1404 may communicate in association with the UE capability indication.

The transmission component 1404 may transmit, based on the spatial configuration switching capability indication, a spatial configuration switch indication.

The reception component 1402 may receive a CSI report in associated with an SBFD configuration in which a set of flexible symbols are configured as SBFD symbols with an uplink subband, wherein the CSI report comprises a first CSI feedback hypothesis associated with a UE full duplex mode and a second CSI feedback hypothesis associated with a UE half duplex mode. The transmission component 1404 may transmit, in association with the CSI report, configuration information indicating a first set of transmission parameters for a first set of symbols associated with the UE full duplex mode and a second set of transmission parameters for a second set of symbols associated with the UE half duplex mode.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components.

Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: transmitting UE capability information associated with a subband full duplex (SBFD) configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and communicating in association with the UE capability indication.

Aspect 2: The method of Aspect 1, wherein the filter switching capability indication is indicative of a classification of a plurality of potential classifications associated with the UE.

Aspect 3: The method of Aspect 2, wherein each classification of the plurality of potential classifications is associated with a filter capability of a plurality of filter capabilities.

Aspect 4: The method of Aspect 3, wherein a first classification of the plurality of potential classifications is associated with a first filter capability of the plurality of filter capabilities, and wherein the first filter capability indicates that the UE supports only a fixed wideband filter.

Aspect 5: The method of Aspect 4, wherein the fixed wideband filter is associated with subband full duplex symbols and half duplex symbols.

Aspect 6: The method of Aspect 4, wherein the fixed wideband filter is at least one of an uplink filter or a downlink filter, and wherein the one or more processors, to communicate in association with the UE capability indication, are configured to cause the UE to communicate, based on an uplink bandwidth changing between communication direction schemes associated with the set of flexible or downlink symbols configured as SBFD symbols, in an absence of a scheduling offset associated with a filter retuning operation.

Aspect 7: The method of Aspect 3, wherein a second classification of the plurality of potential classifications is associated with a second filter capability of the plurality of filter capabilities, and wherein the second filter capability indicates that the UE supports an adaptive uplink filter or an adaptive downlink filter only at a boundary between a semi-static configured SBFD time unit and a non-SBFD time unit.

Aspect 8: The method of Aspect 7, wherein the semi-static configured SBFD time unit comprises at least one of a first symbol or a first slot and wherein the non-SBFD time unit comprises at least one of a second symbol or a second slot.

Aspect 9: The method of Aspect 7, wherein a third classification of the plurality of potential classifications is associated with a third filter capability of the plurality of filter capabilities, and wherein the third filter capability comprises the second filter capability and indicates that the UE supports filter adaptation across flexible symbols that are semi-statically configured as SBFD symbols.

Aspect 10: The method of Aspect 9, wherein the SBFD symbols include one or more resources outside an uplink subband configurable as uplink or downlink resources, and wherein the one or more resources can be configured as an uplink resource in a first symbol of the SBFD symbols and a downlink resource in a second symbol of the SBFD symbols.

Aspect 11: The method of Aspect 9, wherein communicating in association with the UE capability indication comprises communicating, based on an uplink bandwidth changing between communication direction schemes associated with the set of flexible or downlink symbols configured as SBFD symbols, in association with a scheduling offset associated with a filter retuning operation.

Aspect 12: The method of any of Aspects 1-11, wherein communicating in association with the UE capability indication comprises: transmitting, in accordance with a first uplink filter mode, a first communication in an uplink subband of an SBFD symbol of the set of flexible or downlink symbols configured as SBFD symbols; transmitting, in accordance with a second uplink filter mode, a second communication in a full band uplink symbol; and transitioning, after completing the transmitting the second communication, to the first uplink filter mode.

Aspect 13: The method of Aspect 12, wherein the first uplink filter mode comprises a default filter mode.

Aspect 14: The method of Aspect 12, wherein transitioning to the first uplink filter mode comprises transitioning to the first uplink filter mode based on a default indication, wherein the default indication comprises at least one of an indication stored in one or more memories of the UE, an indication included in configuration information received by the UE, or an indication included in the UE capability information.

Aspect 15: The method of any of Aspects 1-14, wherein communicating in association with the UE capability indication comprises: receiving, in accordance with a first downlink filter mode, a first communication in a downlink subband of an SBFD symbol of the set of flexible or downlink symbols configured as SBFD symbols; receiving, in accordance with a second uplink filter mode, a second communication in a full band downlink symbol; and transitioning, after completing the transmitting the second communication, to the first downlink filter mode.

Aspect 16: The method of Aspect 15, wherein the first downlink filter mode comprises a default filter mode.

Aspect 17: The method of Aspect 15, wherein transitioning to the first downlink filter mode comprises transitioning to the first downlink filter mode based on a default indication, wherein the default indication comprises at least one of an indication stored in one or more memories of the UE, an indication included in configuration information received by the UE, or an indication included in the UE capability information.

Aspect 18: The method of any of Aspects 1-17, wherein communicating in association with the UE capability indication comprises: transmitting, in accordance with a first uplink filter mode, a first communication in an uplink subband of an SBFD symbol of the set of flexible or downlink symbols configured as SBFD symbols; transmitting, in accordance with a second uplink filter mode, a second communication in a full band uplink symbol; and maintaining, after completing the transmitting the second communication, the second uplink filter mode.

Aspect 19: The method of Aspect 18, wherein the first uplink filter mode comprises a latest filter mode.

Aspect 20: The method of Aspect 18, wherein transitioning to the first uplink filter mode comprises transitioning to the first uplink filter mode based on a default indication, wherein the default indication comprises at least one of an indication stored in one or more memories of the UE, an indication included in configuration information received by the UE, or an indication included in the UE capability information.

Aspect 21: The method of any of Aspects 1-20, wherein communicating in association with the UE capability indication comprises: receiving, in accordance with a first downlink filter mode, a first communication in a downlink subband of an SBFD symbol of the set of flexible or downlink symbols configured as SBFD symbols; receiving, in accordance with a second downlink filter mode, a second communication in a full band downlink symbol; and maintaining, after completing the transmitting the second communication, the second downlink filter mode.

Aspect 22: The method of Aspect 21, wherein the first downlink filter mode comprises a latest filter mode.

Aspect 23: The method of Aspect 21, wherein transitioning to the first downlink filter mode comprises transitioning to the first downlink filter mode based on a default indication, wherein the default indication comprises at least one of an indication stored in one or more memories of the UE, an indication included in configuration information received by the UE, or an indication included in the UE capability information.

Aspect 24: The method of any of Aspects 1-23, wherein the UE capability indication comprises an indication that the UE supports dynamic bandwidth switching.

Aspect 25: The method of Aspect 24, wherein the UE supports only a default wideband filter.

Aspect 26: The method of Aspect 24, wherein the UE supports uplink or downlink filter adaptation.

Aspect 27: The method of any of Aspects 1-26, wherein the UE capability indication is indicative of a failure of the UE to support dynamic bandwidth switching.

Aspect 28: The method of Aspect 27, wherein communicating in association with the UE capability indication comprises transmitting uplink transmissions only scheduled within the uplink subband or receiving downlink transmissions only scheduled within a downlink sub-band.

Aspect 29: The method of Aspect 28, wherein transmitting the uplink transmissions comprises transmitting the uplink transmissions in association with a default narrowband uplink filter.

Aspect 30: The method of Aspect 28, wherein receiving the downlink transmissions comprises receiving the downlink transmissions in association with a default narrowband downlink filter.

Aspect 31: The method of any of Aspects 1-30, wherein the UE capability indication indicates that the UE supports switching between a semi-static configured SBFD symbol and a non-SBFD symbol without a guard period.

Aspect 32: The method of any of Aspects 1-31, wherein the UE capability indication indicates that the UE supports switching between a semi-static configured SBFD symbol and a non-SBFD symbol with a guard period.

Aspect 33: The method of any of Aspects 1-32, wherein the UE capability indication comprises the spatial configuration switching capability.

Aspect 34: The method of Aspect 33, further comprising receiving, based on the spatial configuration switching capability indication, a spatial configuration switch indication.

Aspect 35: The method of Aspect 33, wherein receiving the spatial configuration switch indication comprises receiving downlink control information comprising the spatial configuration switch indication.

Aspect 36: The method of Aspect 33, wherein a spatial configuration switch rule is maintained in one or more memories of the UE.

Aspect 37: The method of Aspect 33, wherein the spatial configuration switching capability indication is associated with a guard period for switching between the UE full duplex mode and the UE half duplex mode.

Aspect 38: The method of Aspect 37, wherein the UE capability information indicates a length of the guard period.

Aspect 39: The method of Aspect 37, wherein an indication of a length of the guard period is maintained in one or more memories of a network node.

Aspect 40: The method of Aspect 37, wherein a length of the guard period comprises a maximum value of a filter retuning latency value and a spatial configuration switching latency value.

Aspect 41: The method of Aspect 37, wherein the spatial configuration switching capability is associated with switching between a first spatial configuration for the UE full duplex mode and a second spatial configuration for the UE half duplex mode.

Aspect 42: A method of wireless communication performed by a network node, comprising: receiving, from a user equipment (UE), user equipment (UE) capability information associated with a subband full duplex (SBFD) configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and communicating in association with the UE capability indication.

Aspect 43: The method of Aspect 42, wherein the filter switching capability indication is indicative of a classification of a plurality of potential classifications associated with the UE.

Aspect 44: The method of Aspect 43, wherein each classification of the plurality of potential classifications is associated with a filter capability of a plurality of filter capabilities.

Aspect 45: The method of Aspect 43, wherein a first classification of the plurality of potential classifications is associated with a first filter capability of the plurality of filter capabilities, and wherein the first filter capability indicates that the UE supports only a fixed wideband filter.

Aspect 46: The method of Aspect 45, wherein the fixed wideband filter is associated with subband full duplex symbols and half duplex symbols.

Aspect 47: The method of Aspect 45, wherein the fixed wideband filter is at least one of an uplink filter or a downlink filter.

Aspect 48: The method of Aspect 45, wherein a second classification of the plurality of potential classifications is associated with a second filter capability of the plurality of filter capabilities, and wherein the second filter capability indicates that the UE supports an adaptive uplink filter or an adaptive downlink filter only at a boundary between a semi-static configured SBFD time unit and a non-SBFD time unit.

Aspect 49: The method of Aspect 48, wherein the semi-static configured SBFD time unit comprises at least one of a first symbol or a first slot and wherein the non-SBFD time unit comprises at least one of a second symbol or a second slot.

Aspect 50: The method of Aspect 48, wherein a third classification of the plurality of potential classifications is associated with a third filter capability of the plurality of filter capabilities, and wherein the third filter capability comprises the second filter capability and indicates that the UE supports filter adaptation across flexible symbols that are semi-statically configured as SBFD symbols.

Aspect 51: The method of Aspect 50, wherein the SBFD symbols include one or more resources configurable as uplink or downlink resources, and wherein the one or more resources can be configured as an uplink resource in a first symbol of the SBFD symbols and a downlink resource in a second symbol of the SBFD symbols.

Aspect 52: The method of Aspect 50, wherein communicating in association with the UE capability indication comprises communicating, based on an uplink bandwidth changing between communication direction schemes associated with the set of flexible or downlink symbols configured as SBFD symbols, in association with a scheduling offset associated with a filter retuning operation.

Aspect 53: The method of any of Aspects 42-52, wherein the UE capability indication comprises an indication that the UE supports dynamic bandwidth switching.

Aspect 54: The method of any of Aspects 42-53, wherein the UE capability indication is indicative of a failure of the UE to support dynamic bandwidth switching.

Aspect 55: The method of Aspect 62, wherein communicating in association with the UE capability indication comprises receiving uplink transmissions only scheduled within the uplink subband or transmitting downlink transmissions only scheduled within a downlink sub-band.

Aspect 56: The method of any of Aspects 42-55, wherein the UE capability indication indicates that the UE supports switching between a semi-static configured SBFD symbol and a non-SBFD symbol without a guard period.

Aspect 57: The method of any of Aspects 42-56, wherein the UE capability indication indicates that the UE supports switching between a semi-static configured SBFD symbol and a non-SBFD symbol with a guard period.

Aspect 58: The method of any of Aspects 42-57, wherein the UE capability indication comprises the spatial configuration switching capability.

Aspect 59: The method of Aspect 58, further comprising transmitting, based on the spatial configuration switching capability indication, a spatial configuration switch indication.

Aspect 60: The method of Aspect 59, wherein transmitting the spatial configuration switch indication comprises transmitting downlink control information comprising the spatial configuration switch indication.

Aspect 61: The method of Aspect 58, wherein the spatial configuration switching capability indication is associated with a guard period for switching between the UE full duplex mode and the UE half duplex mode.

Aspect 62: The method of Aspect 61, wherein the UE capability information indicates a length of the guard period.

Aspect 63: The method of Aspect 61, wherein an indication of a length of the guard period is maintained in one or more memories of the network node.

Aspect 64: The method of Aspect 61, wherein a length of the guard period comprises a maximum value of a filter retuning latency value and a spatial configuration switching latency value.

Aspect 65: The method of Aspect 61, wherein the spatial configuration switching capability is associated with switching between a first spatial configuration for the UE full duplex mode and a second spatial configuration for the UE half duplex mode.

Aspect 66: A method of wireless communication performed by a user equipment (UE), comprising: transmitting a channel state information (CSI) report in associated with a subband full duplex (SBFD) configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and receiving, in association with the CSI report, configuration information indicating a first set of transmission parameters for a first set of symbols associated with the UE full duplex mode and a second set of transmission parameters for a second set of symbols associated with the UE half duplex mode.

Aspect 67: The method of Aspect 66, wherein the first CSI feedback hypothesis includes a set of feedback derived assuming the UE full duplex mode and the second CSI feedback hypothesis includes a set of feedback derived assuming the UE half duplex mode.

Aspect 68: The method of any of Aspects 66-67, wherein the CSI report includes at least one of: a periodic CSI report, a semi-persistent CSI report, or an aperiodic CSI report.

Aspect 69: A method of wireless communication performed by a network node, comprising: receiving a channel state information (CSI) report in associated with a subband full duplex (SBFD) configuration in which a set of flexible or downlink symbols are configured as SBFD symbols with at least an uplink subband, wherein the CSI report comprises a first CSI feedback hypothesis associated with a user equipment (UE) full duplex mode and a second CSI feedback hypothesis associated with a UE half duplex mode; and transmitting, in association with the CSI report, configuration information indicating a first set of transmission parameters for a first set of symbols associated with the UE full duplex mode and a second set of transmission parameters for a second set of symbols associated with the UE half duplex mode.

Aspect 70: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-69.

Aspect 71: An apparatus for wireless communication at a device, the apparatus comprising one or more memories and one or more processors coupled to the one or more memories, the one or more processors configured to cause the device to perform the method of one or more of Aspects 1-69.

Aspect 72: An apparatus for wireless communication, the apparatus comprising at least one means for performing the method of one or more of Aspects 1-69.

Aspect 73: A non-transitory computer-readable medium storing code for wireless communication, the code comprising instructions executable by one or more processors to perform the method of one or more of Aspects 1-69.

Aspect 74: A non-transitory computer-readable medium storing a set of instructions for wireless communication, the set of instructions comprising one or more instructions that, when executed by one or more processors of a device, cause the device to perform the method of one or more of Aspects 1-69.

Aspect 75: A device for wireless communication, the device comprising a processing system that includes one or more processors and one or more memories coupled with the one or more processors, the processing system configured to cause the device to perform the method of one or more of Aspects 1-69.

Aspect 76: An apparatus for wireless communication at a device, the apparatus comprising one or more memories and one or more processors coupled to the one or more memories, the one or more processors individually or collectively configured to cause the device to perform the method of one or more of Aspects 1-69.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
transmit UE capability information associated with a subband full duplex (SBFD) configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and
communicate in association with the UE capability indication.

2. The apparatus of claim 1, wherein the filter switching capability indication is indicative of a classification of a plurality of potential classifications associated with the UE.

3. The apparatus of claim 2, wherein each classification of the plurality of potential classifications is associated with a filter capability of a plurality of filter capabilities.

4. The apparatus of claim 3, wherein a first classification of the plurality of potential classifications is associated with a first filter capability of the plurality of filter capabilities, and wherein the first filter capability indicates that the UE supports only a fixed wideband filter.

5. The apparatus of claim 4, wherein the fixed wideband filter is associated with subband full duplex symbols and half duplex symbols.

6. The apparatus of claim 4, wherein the fixed wideband filter is at least one of an uplink filter or a downlink filter, and wherein the one or more processors, to communicate in association with the UE capability indication, are configured to cause the UE to communicate, based on an uplink bandwidth changing between communication direction schemes associated with the set of flexible or downlink symbols configured as SBFD symbols, in an absence of a scheduling offset associated with a filter retuning operation.

7. The apparatus of claim 3, wherein a second classification of the plurality of potential classifications is associated with a second filter capability of the plurality of filter capabilities, and wherein the second filter capability indicates that the UE supports an adaptive uplink filter or an adaptive downlink filter only at a boundary between a semi-static configured SBFD time unit and a non-SBFD time unit.

8. The apparatus of claim 7, wherein the semi-static configured SBFD time unit comprises at least one of a first symbol or a first slot and wherein the non-SBFD time unit comprises at least one of a second symbol or a second slot.

9. The apparatus of claim 7, wherein a third classification of the plurality of potential classifications is associated with a third filter capability of the plurality of filter capabilities, and wherein the third filter capability comprises the second filter capability and indicates that the UE supports filter adaptation across flexible symbols that are semi-statically configured as SBFD symbols.

10. The apparatus of claim 9, wherein the SBFD symbols include one or more resources outside an uplink subband configurable as uplink or downlink resources, and wherein the one or more resources can be configured as an uplink resource in a first symbol of the SBFD symbols and a downlink resource in a second symbol of the SBFD symbols.

11. The apparatus of claim 7, wherein the one or more processors, to cause the UE to communicate in association with the UE capability indication, are configured to cause the UE to communicate, based on an uplink bandwidth changing between communication direction schemes associated with the set of flexible or downlink symbols configured as SBFD symbols, in association with a scheduling offset associated with a filter retuning operation.

12. The apparatus of claim 1, wherein the one or more processors, to cause the UE to communicate in association with the UE capability indication, are configured to cause the UE to:
transmit, in accordance with a first uplink filter mode, a first communication in an uplink subband of an SBFD symbol of the set of flexible or downlink symbols configured as SBFD symbols;
transmit, in accordance with a second uplink filter mode, a second communication in a full band uplink symbol; and
transition, after completing the transmitting the second communication, to the first uplink filter mode.

13. The apparatus of claim 12, wherein the first uplink filter mode comprises a default filter mode.

14. The apparatus of claim 12, wherein the one or more processors, to cause the UE to transition to the first uplink filter mode, are configured to cause the UE to transition to the first uplink filter mode based on a default indication, wherein the default indication comprises at least one of an indication stored in one or more memories of the UE, an indication included in configuration information received by the UE, or an indication included in the UE capability information.

15. The apparatus of claim 1, wherein the one or more processors, to cause the UE to communicate in association with the UE capability indication, are configured to cause the UE to:
receive, in accordance with a first downlink filter mode, a first communication in a downlink subband of an SBFD symbol of the set of flexible or downlink symbols configured as SBFD symbols;
receive, in accordance with a second uplink filter mode, a second communication in a full band downlink symbol; and
transition, after completing the transmitting the second communication, to the first downlink filter mode.

16. The apparatus of claim 1, wherein the one or more processors, to cause the UE to communicate in association with the UE capability indication, are configured to cause the UE to:
transmit, in accordance with a first uplink filter mode, a first communication in an uplink subband of an SBFD symbol of the set of flexible or downlink symbols configured as SBFD symbols;
transmit, in accordance with a second uplink filter mode, a second communication in a full band uplink symbol; and
maintain, after completing the transmitting the second communication, the second uplink filter mode.

17. The apparatus of claim 16, wherein the one or more processors, to cause the UE to transition to the first uplink filter mode, are configured to cause the UE to transition to the first uplink filter mode based on a default indication, wherein the default indication comprises at least one of an indication stored in one or more memories of the UE, an indication included in configuration information received by the UE, or an indication included in the UE capability information.

18. The apparatus of claim 1, wherein the one or more processors, to cause the UE to communicate in association with the UE capability indication, are configured to cause the UE to:
receive, in accordance with a first downlink filter mode, a first communication in a downlink subband of an SBFD symbol of the set of flexible or downlink symbols configured as SBFD symbols;
receive, in accordance with a second downlink filter mode, a second communication in a full band downlink symbol; and
maintain, after completing the transmitting the second communication, the second downlink filter mode.

19. The apparatus of claim 18, wherein the first downlink filter mode comprises a latest filter mode.

20. The apparatus of claim 18, wherein the one or more processors, to cause the UE to transition to the first uplink filter mode, are configured to cause the UE to transition to the first downlink filter mode based on a default indication, wherein the default indication comprises at least one of an indication stored in one or more memories of the UE, an indication included in configuration information received by the UE, or an indication included in the UE capability information.

21. The apparatus of claim 1, wherein the UE capability indication comprises an indication that the UE supports dynamic bandwidth switching.

22. The apparatus of claim 1, wherein the UE capability indication is indicative of a failure of the UE to support dynamic bandwidth switching.

23. The apparatus of claim 22, wherein the one or more processors, to cause the UE to communicate in association with the UE capability indication, are configured to cause the UE to transmit uplink transmissions only scheduled within the uplink subband or receiving downlink transmissions only scheduled within a downlink sub-band.

24. The apparatus of claim 1, wherein the one or more processors are further configured to cause the UE to receive, based on the spatial configuration switching capability indication, a spatial configuration switch indication.

25. An apparatus for wireless communication at a network node, comprising:
one or more memories; and
one or more processors, coupled to the one or more memories, configured to cause the network node to:
receive, from a user equipment (UE), user equipment (UE) capability information associated with a subband full duplex (SBFD) configuration in which a set of flexible or downlink symbols are configured as SBFD symbols with at least an uplink subband, wherein the UE capability information comprises a UE capability indication related to at least one of a filter switching capability or a spatial configuration switching capability associated with switching between a UE full duplex mode and a UE half duplex mode; and
communicate in association with the UE capability indication.

26. The apparatus of claim 25, wherein the filter switching capability indication is indicative of a classification of a plurality of potential classifications associated with the UE.

27. The apparatus of claim 25, wherein the UE capability indication comprises the spatial configuration switching capability.

28. The apparatus of claim 27, wherein the one or more processors are further configured to cause the network node to transmit, based on the spatial configuration switching capability indication, a spatial configuration switch indication.

29. An apparatus for wireless communication at an UE, comprising:
one or more memories; and
one or more processors, coupled to the one or more memories, configured to cause the UE to:
transmit a channel state information (CSI) report in associated with a subband full duplex (SBFD) configuration in which a set of flexible or downlink symbols are configured as SBFD symbols with at least an uplink subband, wherein the CSI report comprises a first CSI feedback hypothesis associated with a UE full duplex mode and a second CSI feedback hypothesis associated with a UE half duplex mode; and
receive, in association with the CSI report, configuration information indicating a first set of transmission parameters for a first set of symbols associated with the UE full duplex mode and a second set of transmission parameters for a second set of symbols associated with the UE half duplex mode.

30. An apparatus for wireless communication at a network node, comprising:
one or more memories; and
one or more processors, coupled to the one or more memories, configured to cause the network node to:
receive a channel state information (CSI) report in associated with a subband full duplex (SBFD) configuration in which a set of flexible or downlink symbols are configured as SBFD symbols with at least an uplink subband, wherein the CSI report comprises a first CSI feedback hypothesis associated with a user equipment (UE) full duplex mode and a second CSI feedback hypothesis associated with a UE half duplex mode; and
transmit, in association with the CSI report, configuration information indicating a first set of transmission parameters for a first set of symbols associated with the UE full duplex mode and a second set of transmission parameters for a second set of symbols associated with the UE half duplex mode.
